(19) United States
(12) Patent Application Publication
(10) Pub. No.: US 2024/0009059 A1
(43) Pub. Date: Jan. 11, 2024

(54) PROGRAM AND SYSTEM FOR CONTROLLING DEVICE FOR ASSISTING MOVEMENT OF PART OF INTEREST OF SUBJECT, AND METHOD FOR CONFIGURING DEVICE FOR ASSISTING MOVEMENT OF PART OF INTEREST OF SUBJECT

(71) Applicant: Meltin MMI Co., Ltd., Tokyo (JP)

(72) Inventors: Masahiro KASUYA, Tokyo (JP); Tatsuya SEKI, Tokyo (JP)

(73) Assignee: Meltin MMI Co., Ltd., Tokyo (JP)

(21) Appl. No.: 18/254,527

(22) PCT Filed: Nov. 26, 2021
(86) PCT No.: PCT/JP2021/043366

§ 371 Date: May 25, 2023

(30) Foreign Application Priority Data
Nov. 27, 2020 (JP) 2020-197223

(51) Int. Cl. A61H 1/02

(52) U.S. Cl. CPC A61H 1/0288; A61H 2201/1638; A61H 2230/08

(57) ABSTRACT

This program for controlling a device for assisting movement of a part of interest of a subject is executed in a computer system including a processor unit. The program causes the processor unit to perform: receiving a first signal when the subject is attempting to move the part of interest with a first movement, the first signal indicating at least a first biological signal when the subject is attempting to move the part of interest with the first movement, an unassisted movement range of the part of interest when the subject is attempting to move the part of interest with the first movement, and the magnitude of force when the subject is attempting to move the part of interest with the first movement; selecting a mode for controlling the device on the basis of the received first signal; and controlling the device in the selected mode.

### TECHNICAL FIELD

The present invention relates to a system for supporting the movement of a target part of a subject, a program for controlling a device for supporting the movement of a target part of a subject, and a method of configuring a device for assisting the movement of a target part of a subject.

### BACKGROUND ART

For finger rehabilitation (also referred to simply as “rehabilitation”), there is known an assist device that is worn on the fingers of a subject and assists the movement of the subject (for example, Patent Literature 1).

### CITATION LIST

### Patent Literature

[PTL 1] Japanese Laid-Open Publication No. 2018-108359

### SUMMARY OF INVENTION

### Technical Problem

The inventors have been performing rehabilitation on subjects by combining biological signals acquired from a subject with a device for assisting the movement of the subject. Specifically, the inventors perform rehabilitation of a subject by recognizing the movement intended by the subject from the biological signal acquired from the subject, and driving the device so as to assist the movement intended by the subject.

However, the magnitude of movement of the target part of the subject, the output of force, the intensity of the biological signal, etc., differ from subject to subject, and depending on the subject, it may be difficult to appropriately recognize the intended movement from the biological signal. For subjects whose intended movements are difficult to recognize, the device for assisting the subject's movement must be set up differently, or such a device for assisting the subject's movement is not even available.

The present invention has been made in view of the above circumstances, and an objective of the present invention is to provide a program for controlling a device for assisting the movement of a target part of a subject, a system therefor, a method for configuring a device for assisting the movement of a target part of a subject, and the like.

### Solution to Problem

The present invention provides, for example, the following items.

### (Item 1)

A program for controlling a device for assisting movement of a target part of a subject, the program being executed in a computer system comprising a processor unit, the program causing the processor unit to perform processing comprising:
receiving a first signal at which the subject is attempting to move the target part with a first movement, wherein the first signal at least indicates a first biological signal at which the subject is attempting to move the target part with the first movement, a self-movable range of the target part at which the subject is attempting to move the target part with the first movement, and a magnitude of force at which the subject is attempting to move the target part with the first movement;
selecting a mode for controlling the device based on the received first signal; and
controlling the device in the selected mode.

### (Item 2)

The program of item 1, further comprising:
determining that the magnitude of the force is less than a predetermined threshold; and
receiving, as a first biological signal, a biological signal labeled to indicate the intention of making the first movement if the magnitude of the force is less than the predetermined threshold.

### (Item 3)

The program of item 1 or 2, wherein selecting a mode for controlling the device comprises: selecting a movement sensing mode when the subject is moving the target part within the self-movable range, and
wherein controlling the device in the movement sensing mode comprises:
sensing a movement by the target part of the subject; and controlling the device based on the sensed movement so as not to interfere with the movement.

### (Item 4)

The program of any one of items 1 to 3, wherein selecting a mode for controlling the device comprises:
selecting a biological signal sensing mode at which the subject is moving the target part outside the self-movable range, and
   wherein controlling the device in the biological signal sensing mode comprises:
receiving a biological signal acquired when the subject intends to move the target part;
determining that the movement intended by the subject is the first movement based on the biological signal; and
controlling the device to assist the first movement.

### (Item 5)

The program of any one of items 1 to 4, further comprising:
receiving a second signal at which the subject is attempting to move the target part with a second movement, wherein the second signal at least indicates a second biological signal at which the subject is attempting to move the target part with the second movement, a self-movable range of the target part at which the subject is attempting to move the target part with the second movement, and a magnitude of force at which the subject is attempting to move the target part with the second movement, wherein selecting a mode for controlling the device comprises:

selecting a mode for controlling the device based on the first signal and the second signal.

### (Item 6)

The program of item 5, wherein selecting a mode for controlling the device comprises:
determining whether the first biological signal can be distinguished from the second biological signal by features thereof; and
selecting a first mode, when the first biological signal can be distinguished from the second biological signal by the features thereof.

### (Item 7)

The program of item 6, further comprising: learning the feature of the first biological signal and the feature of the second biological signal when the first mode is selected; wherein controlling the device in the first mode comprises:
receiving a biological signal acquired when the subject intends to move the target part;
determining whether the movement intended by the subject is the first movement or the second movement based on the learned features; and
controlling the device to support the determined movement.

### (Item 8)

The program of any one of items 5 to 7, wherein selecting the mode for controlling the device comprises:
determining whether the first biological signal can be distinguished from the second biological signal by features thereof;
determining, when the first biological signal cannot be distinguished from the second biological signal by the features thereof, whether a biological signal at which the subject is in a state of weakness can be distinguished from the first biological signal or the second biological signal by intensity thereof;
selecting a second mode, when the biological signal at which the subject is in a state of weakness can be distinguished from the first biological signal or the second biological signal by the intensity thereof; and
selecting a third mode, when the biological signal at which the subject is in a state of weakness cannot be distinguished from the first biological signal or the second biological signal by the intensity thereof.

### (Item 9)

The program of item 8, wherein controlling the device in the second mode comprises:
receiving a biological signal acquired when the subject intends to move the target part;
determining whether the movement intended by the subject is the first movement or the second movement, or a movement of weakness, based on the intensity of the biological signals;
controlling the device to support either one of the first movement and the second movement when the movement intended by the subject is determined to be the first movement or the second movement; and
controlling the device to assist the other one of the first movement and the second movement when the movement intended by the subject is determined to be the movement of weakness.

### (Item 10)

The program of item 8 or 9, further comprising: learning the feature of the first biological signal or the feature of the second biological signal and the feature of the biological signal in the state of weakness, when the third mode is selected, wherein controlling the device in the third mode comprises:
receiving a biological signal acquired when the subject intends to move the target part;
determining whether the movement intended by the subject is the first movement or the second movement, or a movement of weakness, based on the features of the biological signals;
controlling the device to support either one of the first movement and the second movement when the movement intended by the subject is determined to be the first movement or the second movement; and
controlling the device to assist the other one of the first movement and the second movement when the movement intended by the subject is determined to be the movement of weakness.

### (Item 11)

The program of any one of items 5 to 10, wherein selecting the mode for controlling the device comprises:
determining whether the first biological signal can be distinguished from the second biological signal by intensity thereof; and
selecting, when the first biological signal can be distinguished from the second biological signal by the intensity thereof, a fourth mode.

### (Item 12)

The program of item 11, wherein controlling the device in the fourth mode comprises:
receiving a biological signal acquired when the subject intends to move the target part;
determining whether the movement intended by the subject is the first movement or the second movement based on intensity of the biological signal; and
controlling the device to assist the determined movement.

### (Item 13)

The program of any one of items 1 to 12, wherein the target part is a part of the upper body.

### (Item 14)

The program of item 13, wherein the target part is a finger.

### (Item 15)

The program of any one of items 5 to 12, wherewith the first movement is a hand-clenching movement and the second movement is a hand-opening movement.

### (Item 16)

A system for assisting movement of a target part of a subject, the system comprising:
a device for assisting movement of a target part of a subject;
acquisition means of acquiring a biological signal from the subject;
sensing means of sensing movement of the subject; and
control means of controlling the device, the control means configured to perform:
receiving a first signal at which the subject is attempting to move the target part with a first movement, from the acquisition means and the sensing means, wherein the first signal at least indicates a first biological signal at which the subject is attempting to move the target part with the first movement, a self-movable range of the target part at which the subject is attempting to move the target part with the first movement, and a magnitude of force at which the subject is attempting to move the target part with the first movement;
selecting a mode for controlling the device based on the received first signal; and
controlling the device in the selected mode.

### (Item 17)

A method for configuring a device for assisting movement of a target part of a subject, the method comprising:
receiving a first signal at which the subject is attempting to move the target part with a first movement, wherein the first signal at least indicates a first biological signal at which the subject is attempting to move the target part with the first movement, a self-movable range of the target part at which the subject is attempting to move the target part with the first movement, and a magnitude of force at which the subject is attempting to move the target part with the first movement;
selecting a mode for controlling the device based on the received first signal; and
setting the device to the selected mode.

### Advantageous Effects of Invention

According to the present invention, it enables to provide a program for controlling a device for assisting the movement of a target part of a subject, a system therefor, a method for configuring a device for assisting the movement of a target part of a subject, and the like. This allows the device for assisting the movement of a target part of a subject, to be adopted to multiple subjects even if, for example, the magnitude of movement, the output of force, the intensity of the biological signal, etc., differ among the multiple subjects.

### BRIEF DESCRIPTION OF DRAWINGS

FIG. 1 is a diagram showing an example of the configuration of a system 10 for assisting the movement of a target part of a subject.

FIG. 2A is a diagram showing an example of the configuration of the control means 200.

FIG. 2B is a diagram showing an example of the configuration of the control means 200′, which is an alternative embodiment of the control means 200.

FIG. 3 is a diagram showing a relationship between a myoelectric signal functioning as a biological signal and an angle of an arm unit 112 with respect to a base unit 111, as an example of a signal received by a receiving means 210.

FIG. 4 is a flowchart showing an example of processing (processing 400) by the system 10 for assisting the movement of a target part of a subject.

FIG. 5 is a flowchart showing an example of a detailed flow of step S401 in the processing 400 performed by the control means 200′.

FIG. 6 is a flowchart showing another example of processing (processing 600) by the system 10 for assisting the movement of a target part of a subject.

FIG. 7A is a flowchart showing an example of the detailed flow of step S603 in the processing 600.

FIG. 7B is a flowchart showing an example of the detailed flow of step S603 in the processing 600.

FIG. 8 is a flowchart showing an example of processing (processing 800) by the system 10 for assisting the movement of a target part of a subject.

### DESCRIPTION OF EMBODIMENTS

The present invention will be described below. It should be understood that the terms used herein have the meanings commonly used in the art unless otherwise specified. Thus, unless defined otherwise, all technical and scientific terms used herein have the same meaning as commonly understood by one of ordinary skill in the art to which this invention belongs. In case of a contradiction, the present specification (including the definitions) takes precedence.

### Definition of Terms

As used herein, the term “biological signal” refers to a signal acquired from a living body. For example, biological signals include, without limitation to, myoelectric signals indicating muscle activity in a living body, electrocardiographic signals indicative of the activity of the heart of a living body, electroencephalograms indicating brain activity in a living body, nerve signals transmitted in nerve cells, muscle sound signals indicating muscle activity in a living body, muscle hardness signals indicating the hardness of a living body's muscle, and the like.

As used herein, the term “subject” refers to a person who receives movement assistance.

As used herein, the term “target part” refers to a target body part that receives movement assistance. The target part may be a part of the body or may be the whole body.

As used herein, the term “about” means±10% of the numerical value following the word.

Hereinafter, embodiments of the present invention will be described with reference to the drawings.

### (Configuration of System for Assisting the Movement of Target Part of the Subject)

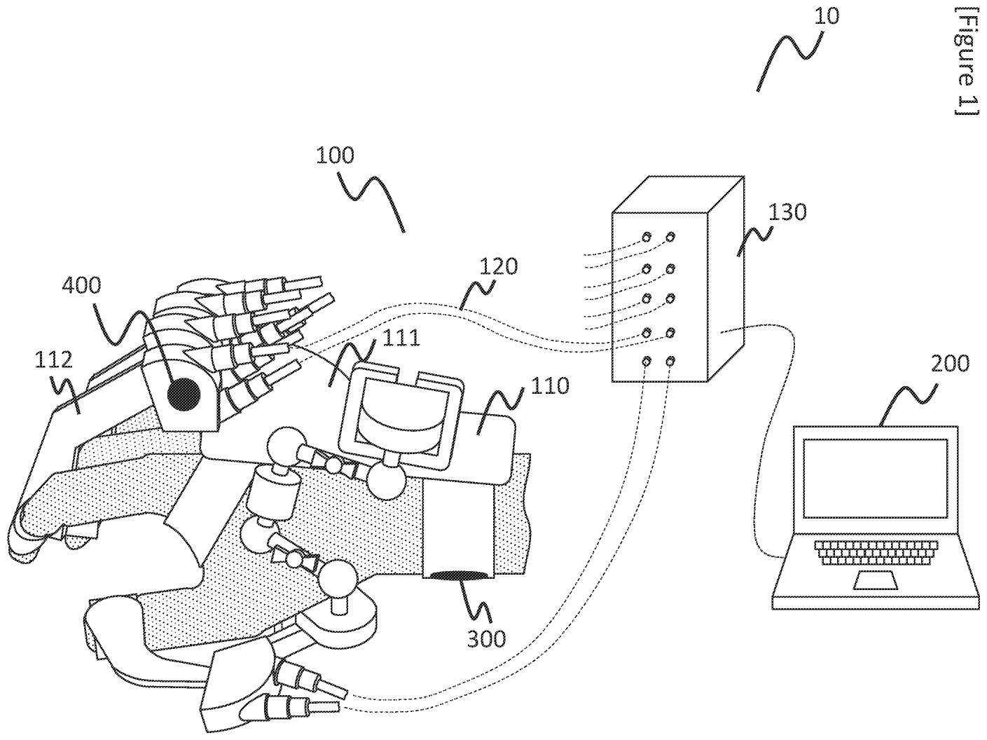

FIG. 1 is a diagram showing an example of the configuration of a system 10 for assisting the movement of a target part of a subject.

The system 10 includes a device 100 for assisting the movement of a target part of a subject, a control means 200 for controlling the device 100, an acquisition means 300 for acquiring biological signals from the subject, and a sensing means 400 for sensing the movement of the subject.

The device 100 is configured to be wearable on a part (target part) of a subject to be rehabilitated. The device 100 is worn on a target part and can assist the movement of the target part by applying force to the target part.

The target part can be any body part. The target part may be, for example, a finger, an arms, a shoulder, a leg, a knee, an ankle, an upper body, a lower body, and the like. Preferably, the target part may be a part of the body that performs voluntary movement. The part of the body performing voluntary movement can be, for example, a part of the upper body.

In the example shown in FIG. 1, fingers are shown as target parts. The device 100 is worn on the fingers, and the device can assist the flexing and extending motion of each finger by applying force around the joints of each finger.

The device 100 can be worn on the target part by any wearing means. The constituent material and shape of the wearing means may be any constituent material and shape that allow the device 100 to be worn on the target part. For example, the wearing means may be made of cloth, leather, resin, paper, or rubber. Further, the shape of the wearing means may be flat plate-like, belt-like, or annular.

In the example shown in FIG. 1, the device 100 is worn on the fingers by winding a belt-shaped wearing means around the fingers.

The device 100 includes a portion 110 that is worn on a target part, and the portion 110 that is worn on the target part includes a base unit 111 and an arm unit 112 that can move relative to the base unit 111. Both the base unit 111 and the arm unit 112 are worn on the target part, and the arm unit 112 is driven so that the arm unit 112 moves with respect to the base unit 111, so that force can be applied to the target part.

The device 100 can drive the arm unit 112 by any drive means. The drive means may be, for example, a wire, a link mechanism, or a rack and pinion. In the example shown in FIG. 1, a wire 120 is shown as the drive means. The driving unit for driving the wire or the like may be any means that are capable of driving a wire and the like. For example, it may be a motor, or an air or hydraulic cylinder. Further, the driving unit may be provided in the portion 110 that is worn on the target part, or may be provided remotely from the portion 110 that is worn on the target part.

In the example shown in FIG. 1, the drive unit 130 for driving the wire 120 is provided remotely from the portion 110 worn on the target part.

The device 100 is controlled by a control means 200. The control means 200 may be any means capable of controlling the device 100. The control means 200 may be, for example, a dedicated controller or a general-purpose information processing device. The control means 200 may be, for example, an information processing device, such as a desktop type device, a laptop type device, a tablet type device, a smartphone type device, or the like. For example, the control means 200 may be installed remotely from the target part, or may be worn on the target part together with the device 100. The control means 200 may be implemented, for example, as means separate from the device 100 or as means mounted within the device 100.

In the example shown in FIG. 1, the control means 200 is shown as a laptop type information processing device.

The control means 200 can send a control signal to the drive unit 130 to control the drive unit 130 and thus the device 100. The control means 200 and the device 100 (or the drive unit 130) are connected in any manner with each other. For example, the control means 200 and the device 100 (or the drive unit 130) may be connected with each other by wire or wirelessly. For example, the control means 200 and the device 100 (or the drive unit 130) may be connected with each other via a network (e.g., Internet, LAN, etc.).

The control means 200 can receive the biological signals acquired by acquisition means 300. The acquisition means 300 may be any means capable of acquiring biological signals from a subject. For example, the acquisition means 300 may be a myoelectric device equipped with a myoelectric sensor capable of detecting a living body's myoelectric signal, an electroencephalograph equipped with an electroencephalogram sensor capable of detecting a living body's electroencephalogram, a neural signal meter equipped with a neural signal sensor capable of directly acquiring biological neural signals, a muscle sound meter including a muscle sound sensor capable of detecting a muscle sound signal of a living body, a muscle hardness meter capable of measuring the hardness of the muscles of a living body, or the like.

The acquisition means 300 may comprise, for example, a detection unit and a transmission unit.

The detection unit may be any means configured to detect biological signals. For example, the detection unit may be a myoelectric sensor capable of detecting myoelectric signals in a living body, an electrocardiographic sensor capable of detecting an electrocardiographic signal in a living body, an electroencephalogram sensor capable of detecting electroencephalograms of a living body, a neural signal sensor capable of directly acquiring biological neural signals, a muscle sound sensor capable of detecting a muscle sound signal of a living body, or the like.

The transmission unit is configured to be able to transmit a signal to the outside of the acquisition means 300. The transmission unit transmits a signal to the outside of the acquisition unit 300 wirelessly or by wire. The transmission unit may transmit the signal using, for example, a wireless LAN such as Wi-fi. The transmission unit may transmit the signal using short-range wireless communication such as Bluetooth®. The transmission unit transmits, for example, the biological signal detected by the detection unit to the control means 200.

The acquisition means 300 and control means 200 are connected in any manner. For example, the acquisition means 300 and the control means 200 may be connected by wire or wirelessly. For example, the acquisition means 300 and control means 200 may be connected via a network (for example, the Internet, LAN, etc.).

The acquisition means 300 can be placed at any position on the subject's body as long as it is such a position that allows the acquisition means to detect the biological signal generated when the subject intends the movement of the target part. For example, when the acquisition means 300 acquires myoelectric signals, the acquisition means 300 can be placed on or near the muscles that move the target part. For example, when the acquisition means 300 acquires electroencephalograms, the acquisition means 300 can be placed on the subject's head.

In the example shown in FIG. 1, one acquisition means 300 is worn on the body; however, any number of acquisition means 300 may be utilized in accordance with the biological signals to be acquired. For example, at least two acquisition means 300 may be utilized, including a first acquisition means for acquiring biological signals primarily from a first movement and a second acquisition means for acquiring biological signals primarily from a second movement.

For example, two acquisition means 300 can be used to acquire a biological signal when the target part is flexed and a biological signal when the target part is extended. In this case, one of the two acquisition means 300 acquires the biological signal when the target part is flexed, and the other of the two acquisition means 300 acquires the biological signal when the target part is extended. For example, in this case, three or more acquisition means 300 may be used, where some of the three or more acquisition means 300 acquire biological signals when the target part is flexed, while some other of the three or more acquisition means 300 acquire biological signals when the target part is extended.

The sensing means 400 is configured to sense the movement of the subject. The sensing means 400 may be provided within the device 100 or may be provided outside the device 100. In the example shown in FIG. 1, the sensing means 400 is provided within the device 100.

The sensing means 400 can sense the movement of the subject, for example, by sensing the relative movement of the arm unit 112 with respect to the base unit 111. The sensing means 400 includes, without limitation to, an angle sensor capable of sensing the angle of the arm unit 112 with respect to the base unit 111, a position sensor capable of sensing the position of the arm unit 112 relative to the base unit 111, and force sensor capable of sensing the force applied to the base unit 111.

The sensing means 400 can, for example, sense the movement of the subject and thereby output a signal indicating the self-movable range of the subject's target part when the subject is moving the target part. The sensing means 400 can also output, for example, a signal indicating that the subject is moving the target part within the self-movable range, and/or a signal indicating that the subject is moving the target part outside the self-movable range.

The sensing means 400 can, for example, sense the movement of the subject and thereby output a signal indicating the magnitude of the force when the subject is moving the target part. The signal indicating the magnitude of the force when the subject is moving the target part may be, for example, a binary signal indicating whether or not the force is exerted, or a multivalued signal indicating the magnitude of the force numerically. For example, the sensing means 400 can apply a constant torque to the arm unit 112 and senses a change in the angle of the arm unit 112 with respect to the base unit 111 to generate a signal indicating the magnitude of the force when the subject is moving the target site. At this time, if the angle change exists, then it means that the subject is at least exerting the power of overcoming the added torque.

The sensing means 400 can, for example, photograph the movement of the subject and sense the movement of the subject from the photographed images (for example, a plurality of still images or moving images). This can be achieved, for example, by known movement capture techniques.

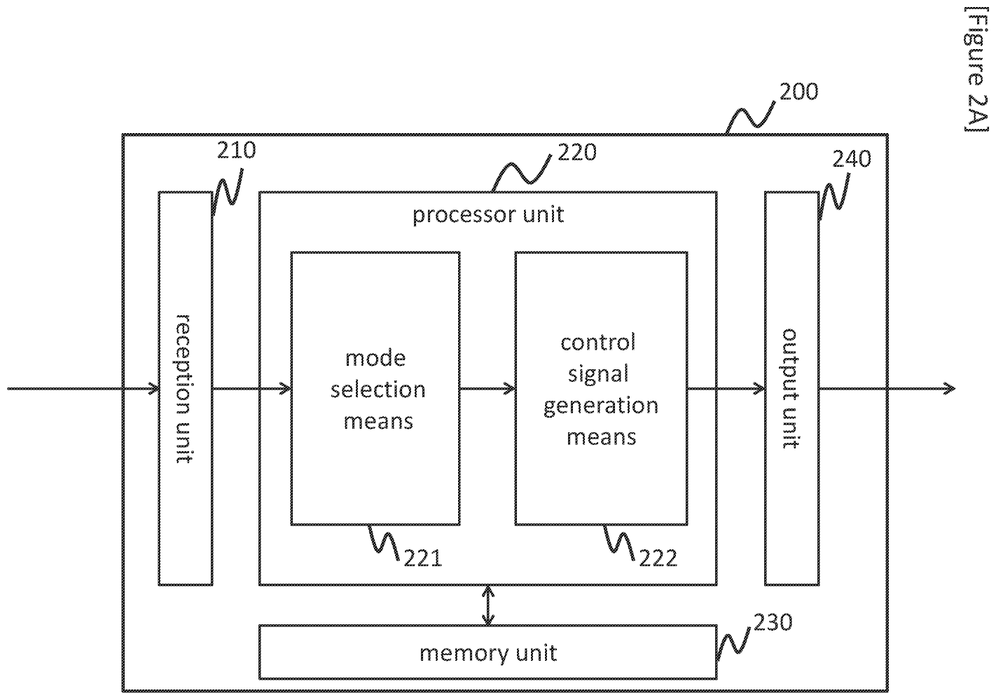

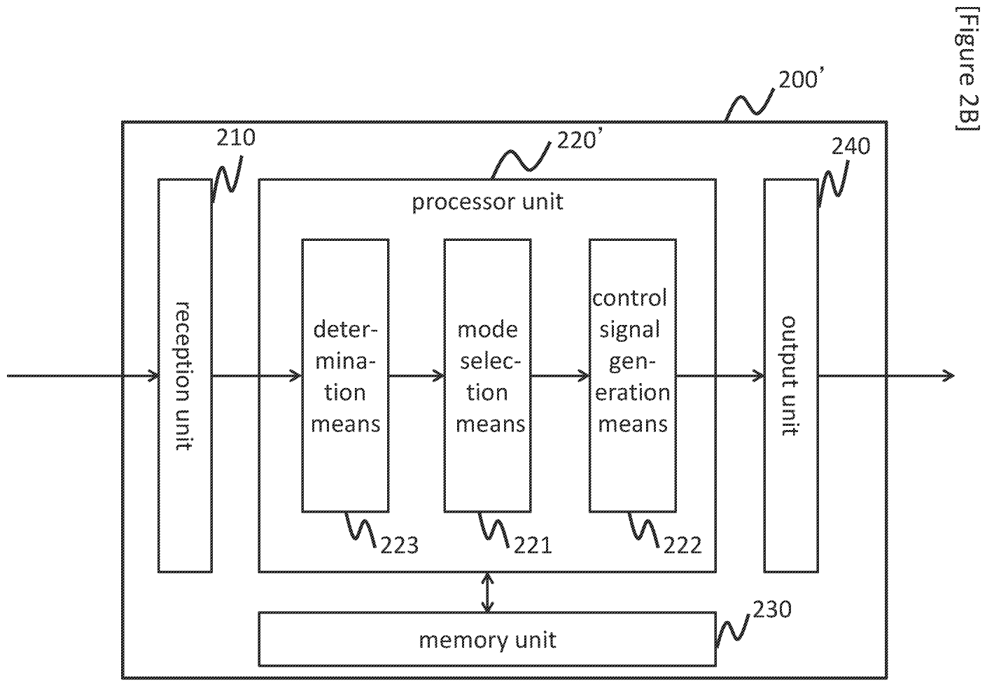

FIG. 2A shows an example of the configuration of the control means 200.

The control means 200 comprises a reception unit 210, a processor unit 220, a memory unit 230 and an output unit 240.

The reception unit 210 is configured to be able to receive a signal from outside the control means 200. The reception unit 210 receives a signal wirelessly or by wire from the outside of the control unit 200. The reception unit 210 may receive signals using, for example, a wireless LAN such as Wi-fi. The reception unit 210 may receive signals using short-range wireless communication such as Bluetooth®. The reception unit 210, for example, receives the biological signal detected by the acquisition means 300 from the acquisition means 300. The reception unit 210, for example, receives signals acquired by the sensing means 400 from the sensing means 400. The reception unit 210, for example, receives signals including biological signals received from the acquisition means 300 and signals received from the sensing means 400. The reception unit 210 receives, for example, an input from a user (e.g., doctor, physical therapist, occupational therapist, rehabilitation trainer, subject, etc.).

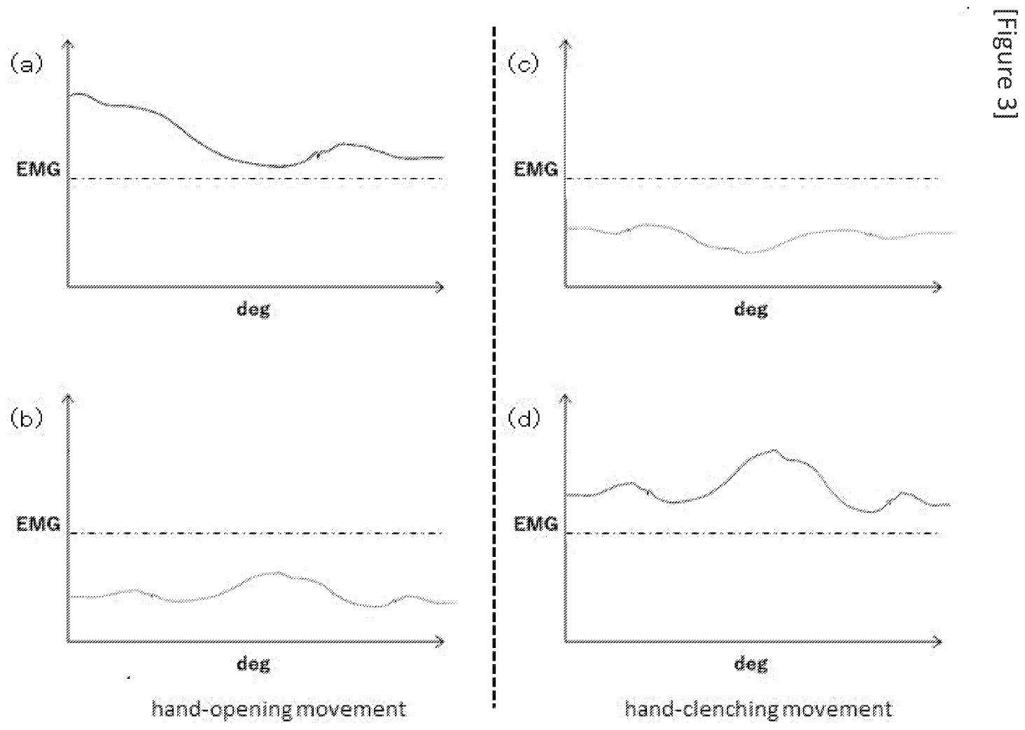

FIG. 3 shows the relationship between a myoelectric signal functioning as a biological signal and the angle of the arm unit 112 with respect to the base unit 111, as an example of the signal received by the receiving means 210.

In FIG. 3, the vertical axis indicates the myoelectric potential (EMG) of the myoelectric signal, and the horizontal axis indicates the angle (deg) of the arm unit 112 with respect to the base unit 111.

FIGS. 3(a) and 3 (b) show an example of the relationship between the myoelectric signal obtained when the hand is opened and the angle. FIG. 3(a) shows the relationship between the myoelectric signal acquired from the myoelectric sensor placed in the position of a muscle (extensor muscle) that exerts the muscle electricity when the target part is extended, and the angle of the arm unit 112 with respect to the base unit 111. FIG. 3(b) shows the relationship between the myoelectric signal acquired from the myoelectric sensor placed in the position of a muscle (flexor muscle) that exerts the muscle electricity when the target part is flexed, and the angle of the arm unit 112 with respect to the base unit 111.

FIGS. 3(c) and 3 (d) show an example of the relationship between the myoelectric signal acquired when the hand is clenched and the angle. FIG. 3(c) shows the relationship between the myoelectric signal acquired from the myoelectric sensor placed in the position of a muscle (extensor muscle) that exerts the muscle electricity when the target part is extended, and the angle of the arm unit 112 with respect to the base unit 111. FIG. 3(d) shows the relationship between the myoelectric signal acquired from the myoelectric sensor placed in the position of a muscle (flexor muscle) that exerts the muscle electricity when the target part is flexed, and the angle of the arm unit 112 with respect to the base unit 111.

The signals shown in FIGS. 3(a) and 3(b) can be labeled as “hand-opening movement” because they include myoelectric signals acquired during the hand-opening movement. The signals shown in FIGS. 3(c) and 3(d) can be labeled as “hand-clenching movement” because they include myoelectric signals acquired when performing a hand-clenching movement.

For example, when a predetermined threshold is provided, the myoelectric signals acquired from the myoelectric sensor placed in the position of an extensor muscle exceed the threshold (indicated by the one dot chain line) as shown in FIG. 3(a), while the myoelectric signals acquired from the myoelectric sensor placed in the position of a flexor muscle do not exceed the threshold (indicated by the one dot chain line) as shown in FIG. 3(b). Therefore, it can be judged that the extensor muscle is demonstrated. For example, the myoelectric signals acquired from the myoelectric sensor placed in the position of an extensor muscle do not exceed the threshold (indicated by the one dot chain line) as shown in FIG. 3(c), while the myoelectric signals acquired from the myoelectric sensor placed in the position of a flexor muscle exceed the threshold (indicated by the one dot chain line) as shown in FIG. 3(d). Therefore, it can be judged that the flexor muscle is demonstrated.

The biological signal received by the receiving means 210 may also contain a time component. That is, the biological signal received by the receiving means 210 can indicate a time series change of the biological signal.

For example, the biological signal received by the receiving means 210 can be represented by a three-dimensional graph acquired by adding a time axis to the graph shown in FIG. 3.

When the biological signal includes a time component, the processor unit 220 can extract the feature of the biological signal by frequency-analyzing the biological signal. The frequency analysis can be, for example, Fourier transform, but is not limited to this. Any method capable of extracting the feature can be used for the frequency analysis.

A feature can have any dimension. For example, the dimensions of the feature may be 2 dimensions, 4 dimensions, 8 dimensions, 9 dimensions, 16 dimensions, 18 dimensions, 27 dimensions, 32 dimensions, and the like. The feature of n-dimension can be represented as a vector having n components (where n is an integer).

For example, if the acquisition means 300 has a first acquisition means (e.g., acquisition means for acquiring biological signals from extensor muscles) and a second acquisition means (e.g., acquisition means for acquiring biological signals from flexor muscles), each feature can be extracted from the biological signal acquired by the first acquisition means and the biological signal acquired by the second acquisition means. In one embodiment, when a feature is extracted from a myoelectric signal as a biological signal, the feature related to the extensor muscle and the feature related to the flexor muscle can be extracted, for example, from the myoelectric signals acquired from the myoelectric sensor placed in the position of an extensor muscle, and the myoelectric signals acquired from the myoelectric sensor placed in the position of a flexor muscle, respectively. At this time, the dimension of the feature may be, for example, 27 dimensions.

For example, the feature may be extracted for each stage of movement of the subject. For example, in the example shown in FIG. 3, the feature may be extracted for each angle of the arm unit 112 with respect to the base unit 111. The angle may be, for example, in increments of 1 degree, may be in increments of 10 degrees, may be in increments of 30 degrees, or may be in increments of 45 degrees. For example, in the case of increments of 30 degrees, the following can be extracted: the feature when the angle θ of the arm unit 112 with respect to the base unit 111 is 0 degrees, the feature when θ=30 degrees, the feature when θ=60 degrees, the feature when θ=90 degrees, the feature when θ=120 degrees . . . .

As mentioned above, the signal can be labeled with the intended movement; thus, in one embodiment, the signal received by the receiving means 210 can be represented by the following vector: (intended movement, angle of the arm unit 112 relative to the base unit 111, n-dimensional feature vector). In one example, the biological signal received when the subject's finger is 30 degrees with respect to the base unit 111 upon making a hand-opening movement can be represented as: (hand-opening movement, 30 degrees, 27 dimensional feature vector). In another embodiment, the biological signal received by the receiving means 210 can be represented by the following vector: (intended movement, angle of the arm unit 112 relative to the base unit 111, n-dimensional feature vector related to the extensor muscle, m-dimensional feature vector related to the flexor muscle). In one example, the biological signal received when the subject's finger is 30 degrees with respect to the base unit 111 upon making a hand-opening movement can be represented as: (hand-opening movement, 30 degrees, 9 dimensional feature vector related to the extensor muscle, 18 dimensional feature vector related to the flexor muscle).

The data about the labeled signal as described above can be processed as data about when an attempt is made to move the target part. For example, it becomes possible to make a comparison (comparison regarding intensity, comparison regarding feature, etc.) between the data about when an attempt is made to move the target part with the first movement (e.g., the hand-opening movement) and the data about when an attempt is made to move the target part with the second movement (e.g., the hand-clenching movement). For example, it also becomes possible to make a comparison (comparison regarding intensity, etc.) between the data about the flexor muscle when an attempt is made to move the target part with the first movement (e.g., the hand-opening movement) and the data about the extensor muscle when an attempt is made to move the target part with the first movement; and a comparison (comparison regarding intensity, etc.) between the data about the flexor muscle when an attempt is made to move the target part with the second movement (e.g., the hand-clenching movement) and the data about the extensor muscle when an attempt is made to move the target part with the second movement. Further, it becomes possible to make a comparison among: the data about when an attempt is made to move the target part with the first movement (e.g., the hand-opening movement); the data about when an attempt is made to move the target part with the second movement (e.g., the hand-clenching movement); and the data about when the subject is in a state of weakness (or when no attempt is made to move the target part). For example, it also becomes possible to make a comparison (comparison regarding intensity, etc.) between the data about the flexor muscle when in a state of weakness (or when no attempt is made to move the target part) and the data about the extensor muscle when in a state of weakness (or when no attempt is made to move the target part). For example, it becomes possible to perform the machine learning of the data about when an attempt is made to move the target part with the first movement and the data about when an attempt is made to move the target part with the second movement; or the machine learning of the data about when an attempt is made to move the target part with the first movement, the data about when an attempt is made to move the target part with the second movement, and the data about when the subject is in a state of weakness.

Referring to FIG. 2A again, the processor unit 220 controls the operation of control means 200 as a whole. The processor unit 220 reads a program stored in the memory unit 230 and executes the program. This allows the control means 200 to function as a device that executes desired steps.

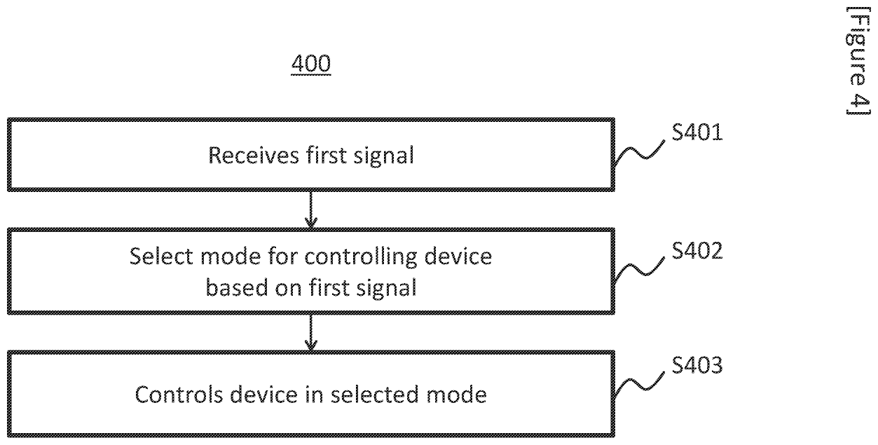

The memory unit 230 stores programs required for the execution of processing, data required for executing the programs, and the like. For example, the memory unit 230 may store a program for implementing the processing for assisting the movement of the target part of the subject (for example, the processing to be described below with reference to FIGS. 4, 5, 6, 7A, 7B, and 8). Here, it is possible to employ any way of storing the program on the memory unit 230. For example, the program may be pre-installed in the memory unit 230. Alternatively, the program may be installed in the memory unit 230 by being downloaded via a network, or may be installed in the memory unit 230 via a storage medium such as an optical disc or USB.

The output unit 240 is configured to be able to output a signal to the outside of the control means 200. The control means 200 is capable of outputting signals to the device 100. The output unit 240 may employ any way of outputting signals. For example, the output unit 240 may transmit signals to the outside of the control means 200 by wire or wirelessly. For example, the output unit 240 may transmit a signal by converting the signal into a format that can be handled by the device 100 to which the signal is to be output, or by adjusting the response speed thereof to a response speed that can be handled by the device 100 to which the signal is output.

The processor unit 220 comprises mode selection means 221 and control signal generation means 222.

The mode selection means 221 is configured to select a mode for controlling the device 100 from a plurality of modes.

The plurality of modes include, for example, a movement sensing mode. The movement sensing mode is a mode in which the control means 200 controls the device 100 based on the subject's movement sensed by the sensing means 400. In the movement sensing mode, the control means 200 can control the device 100 so as not to interfere with the sensed movement of the subject. That is, in the movement sensing mode, the device 100 is driven to counteract the inherent resistance of the device 100 due to, for example, interference between components of the device 100. This allows the subject to move the target part as if the device 100 were not worn. Controlling the device 100 in the movement sensing mode is preferably performed, for example, when the subject is moving the target part within the self-movable range thereof. As a result, when assisting the movement of the target part of the subject, the device 100 can be prevented from interfering with the movement of the subject within the range in which the subject can move by himself. This leads to high efficiency of rehabilitation of subjects. Further, within a range in which the subject can move by himself, erroneous recognition related to biological signal sensing can be reduced by performing the control in the movement sensing mode instead of the biological signal sensing mode described below.

The plurality of modes include, for example, a biological signal sensing mode. The biological signal sensing mode is a mode in which the control means 200 controls the device 100 based on the biological signals acquired by the acquisition means 300. In the biological signal sensing mode, the movement intended by the subject is recognized based on the biological signal, and the device 100 can be controlled to assist the recognized movement. For example, in the biological signal sensing mode, the control means 200 can determine whether the movement intended by the subject is a specific movement, and control the device 100 to assist the determined specific movement. Alternatively, for example, in the biological signal sensing mode, the control means 200 can determine whether the movement intended by the subject is the first movement or the second movement among the plurality of movements, and control the device 100 to assist the determined first or second movement.

The first movement and the second movement can be, for example, paired movements of the target part of the subject. Paired movements include, but are not limited to, for example: flexion and extension; adduction and abduction; internal rotation and external rotation; pronation and supination; and the like. For example, if the target part is a finger, the paired movement may be, for example, hand-clenching and hand-opening (rock and paper).

Although the plurality of movements are described herein with regard to the first movement and the second movement that is different from the first movement, it should be understood that the plurality of movements are not limited to the two, the first movement and the second movement. The plurality of movements can include any number of movements greater than or equal to three, such as a third movement, a fourth movement, and so on. That is, in the biological signal sensing mode, the control means 200 can determine whether the movement intended by the subject is the first movement, the second movement . . . the nth movement (n≥3) and control the device 100 to assist the determined first movement, the second movement . . . or the nth movement.

For example, the device 100 is controlled to drive the arm unit 112 relative to the base unit 111 in the recognized direction of movement. As a result, the subject can achieve the intended movement even if the movement is outside the self-movable range.

The biological signal sensing mode includes, for example, a first mode. The first mode is a mode in which the control means 200 determines whether the movement intended by the subject is the first movement or the second movement among a plurality of movements, based on the feature of the biological signal, and control the device 100 in such a manner to assist the determined movement. In the first mode, the control means 200 determines whether the movement intended by the subject is the first movement or the second movement, based on the feature of the biological signal acquired during the execution of movement assistance; and if the movement intended by the subject is determined as the first movement, the control means 200 controls the device 100 to assist the first movement; and if the movement intended by the subject is determined as the second movement, the control means 200 controls the device 100 to assist the second movement. In the first mode, whether the movement intended by the subject is a movement of weakness (or that the subject does not intend the movement) may also be determined based on the feature of the biological signal. In this case, the control means 200 can be configured not to control the device 100. This makes it possible to prevent the device 100 from being moved when the subject intends to make a movement of weakness (or when the subject does not intend to make a movement).

That is, in the first mode, the control means 200 is configured to determine three states of (1) first movement, (2) second movement, and (3) movement of weakness (or unintended movement) based on the feature of the biological signal acquired during the execution of the assistance so that the control means 200 controls the device 100 to assist the first movement when the subject intends the first movement, to assist the second movement when the subject intends the second movement, and not to assist the movement when the subject intends the movement of weakness (or when the subject does not intend to make a movement).

A feature of a biological signal is extracted by frequency-analyzing the biological signal including a time component. The frequency analysis can be, for example, Fourier transform, but is not limited to this. Any method capable of extracting the feature can be used for the frequency analysis. The feature can have any dimension. For example, the dimensions of the feature can be 2 dimensions, 4 dimensions, 8 dimensions, 9 dimensions, 16 dimensions, 18 dimensions, 27 dimensions, 32 dimensions, and the like. An n-dimensional feature can be expressed as a vector having n components (where n is an integer).

For example, the feature may be extracted for each stage of movement of the subject. A feature can be extracted, for example, for each angle of a joint associated with a target part of a living body. The angle may be, for example, in increments of 1 degree, may be in increments of 10 degrees, may be in increments of 30 degrees, or may be in increments of 45 degrees. For example, in the case of increments of degrees, the feature when the joint angle θ=0 degrees, the feature when θ=30 degrees, the feature when θ=60 degrees, the feature when θ=90 degrees, the features when θ=120 degrees . . . can be extracted.

In the first mode, the control means 200 utilizes a machine learning model prepared in advance to distinguish between the first movement and the second movement, to distinguish between the first movement and the second movement based on the feature of the biological signal. The machine learning model prepared in advance may be a model that has learned the feature of the biological signal and the label attached to the biological signal.

A machine learning model can be, for example, a neural network model. A neural network may have an input layer, a hidden layer, and an output layer. A neural network can comprise one or more hidden layers. The number of nodes in the input layer of the neural network corresponds to the number of dimensions of the input data. The number of nodes in the output layer of the neural network corresponds to the number of dimensions of the output data. The hidden layer of a neural network can contain any number of nodes. A weighting factor for each node of the hidden layer of the neural network can be calculated using the teaching data. The teaching data can be the feature extracted from the biological signal and the label attached to the biological signal. For example, the weighting factor of each node can be calculated so that the value of the output layer at which the feature extracted from the biological signal is input to the input layer, becomes the value corresponding to the label attached to the biological signal. When a 27-dimensional feature extracted from a biological signal is input and two types of first movement or second movement are output, the number of nodes in the input layer is 27, and the number of nodes in the output layer is 2. For example, as will be described below, when the movement stage of the subject is also input, the number of nodes in the input layer is added by one. For example, as will be described below, when three kinds of movements, that is, the first movement, the second movement, and the movement of weakness, are output, the number of nodes in the output layer is three.

For example, a set of teaching data (input teaching data, output teaching data) for learning by the machine learning model so that the machine learning model can distinguish between hand-opening and hand-holding movements may be as follows: (a feature extracted from a biological signal acquired when the hand-opening movement is made, a value indicating the hand-opening movement); and (a feature extracted from a biological signal acquired when the hand-clenching movement is made, a value indicating the hand-clenching movement). It is preferable to acquire teaching data from a plurality of subjects and to allow a plurality of teaching data to be learned. When the machine learning model prepared in this way is input with the feature extracted from the biological signal acquired when the subject makes a certain movement, the machine learning model can output either of a value indicating that the certain movement is the first movement and a value indicating that the certain movement is the second movement.

In one embodiment, a plurality of machine learning models may be prepared for each stage of the subject's movement. For example, a sequence of subject's movements can be divided into a plurality of stages and a machine learning model can be prepared for each stage of the plurality of stages. In one embodiment, when a target part of a living body is moved around a joint associated with that part, a plurality of machine learning models can be prepared for respective joint angles. For example, a plurality of machine learning models can be prepared, including a first machine learning model applicable to joint angles of 0 degrees≤θ<30 degrees, a second machine learning model applicable to joint angles of 30 degrees≤θ<60 degrees, a third machine learning model applicable to joint angles of 60 degrees≤θ<90 degrees, and a fourth machine learning model applicable to joint angles of 90 degrees≤θ. As a result, in accordance with the stage of movement of the subject, it becomes possible to utilize a machine learning model suitable for that stage of movement, and to improve the accuracy of movement recognition.

In another embodiment, the stages of the subject's movement may also be learned by the machine learning model. The teaching data in this case may be a value indicating the stage of a series of movements of the subject, a feature extracted from the biological signal acquired at that stage, and a label attached to the biological signal. For example, a set of teaching data (input teaching data, output teaching data) for making the machine learning model learn so that the machine learning model can distinguish between hand-opening and hand-holding movements may be as follows: ((a value indicating that the joint angle θ=0 degrees, a value at the joint angle θ=0 degrees of the feature extracted from the biological signal acquired when a hand-opening movement is made), a value indicating the hand-opening movement); ((a value indicating that the joint angle θ=30 degrees, a value at the joint angle θ=30 degrees of the feature extracted from the biological signal acquired when a hand-opening movement is made), a value indicating the hand-opening movement); ((a value indicating that the joint angle θ=60 degrees, a value at the joint angle θ=60 degrees of the feature extracted from the biological signal acquired when a hand-opening movement is made), a value indicating the hand-opening movement); ((a value indicating that the joint angle θ=90 degrees, a value at the joint angle θ=90 degrees of the feature extracted from the biological signal acquired when a hand-opening movement is made), a value indicating the hand-opening movement); ((a value indicating that the joint angle θ=0 degrees, a value at the joint angle θ=0 degrees of the feature extracted from the biological signal acquired when a hand-clenching movement is made), a value indicating the hand-clenching movement); ((a value indicating that the joint angle θ=30 degrees, a value at the joint angle θ=30 degrees of the feature extracted from the biological signal acquired when a hand-clenching movement is made), a value indicating the hand-clenching movement); ((a value indicating that the joint angle θ=60 degrees, a value at the joint angle θ=60 degrees of the feature extracted from the biological signal acquired when a hand-clenching movement is made), a value indicating the hand-clenching movement); ((a value indicating that the joint angle θ=90 degrees, a value at the joint angle θ=90 degrees of the feature extracted from the biological signal acquired when a hand-clenching movement is made), a value indicating the hand-clenching movement); and the like. It is preferable to acquire teaching data from a plurality of subjects and to allow a plurality of teaching data to be learned. When the machine learning model prepared in this way is input with: the feature extracted from the biological signal acquired when the subject makes a certain movement; and the joint angle at that time, the machine learning model can output either a value indicating that the certain movement is the first movement or a value indicating that the certain movement is the second movement.

The machine learning model described above has been a two-state distinguishment model that distinguishes between first and second movements. In identifying, for example, the three states of (1) first movement, (2) second movement, and (3) movement of weakness (or unintended movement) as described above, a three-state distinguishment model is used. In the first mode, the first movement and the second movement (and movement of weakness) are distinguished from each other based on the feature of the biological signal. Therefore, even if the difference in the intensity of the biological signal due to the difference in movement is small, the first movement and the second movement (and the movement of weakness) can be distinguished with high accuracy, and the first movement or the second movement can be assisted. The first mode is particularly useful when, for example, the intensity of the biological signal is so similar, or the intensity of the biological signal is so weak, that it is not possible to distinguish between the first movement and the second movement (and the movement of weakness) based on the intensity of the biological signal.

For example, in the case of assisting the hand-clenching movement and hand-opening movement where the biological signal from the hand-clenching movement and the biological signal from the hand-opening movement can be distinguished by the features thereof, if it is determined that the movement intended by the subject is the hand-clenching movement based on the feature of the biological signal acquired during the execution of the movement assistance, the device 100 can be controlled to assist the hand-clenching movement; and if it is determined that the movement intended by the subject is the hand-opening movement, the hand-opening movement can be assisted. Alternatively, for example, when a biological signal from a hand-clenching movement, a biological signal from a hand-opening movement, and a biological signal from a movement of weakness can be distinguished by the features thereof, if it is determined that the movement intended by the subject is the hand-clenching movement based on the intensity of the biological signal acquired during the execution of the movement assistance, the device 100 can be controlled to assist the hand-clenching movement; if it is determined that the movement intended by the subject is the hand-opening movement, the hand-opening movement can be assisted; and if it is determined that the movement intended by the subject is the movement of weakness, the movement can be prevented from being assisted.

The biological signal sensing mode includes, for example, the second mode. The second mode is a mode in which the control means 200 determines whether the movement intended by the subject is the first movement or the second movement, or the movement of weakness, based on the intensity of the biological signal, and control the device 100 in such a manner to assist either the first movement or the second movement. In the second mode, the control means 200 determines whether the movement intended by the subject is the first movement or the second movement, or the movement of weakness, based on the intensity of the biological signal acquired during the execution of movement assistance; and if the movement intended by the subject is determined to be the first movement or the second movement, the device 100 is controlled to assist either one of the first movement and the second movement; and if the movement intended by the subject is determined to be the movement of weakness, the device 100 is controlled to assist the other one of the first movement and the second movement. When the movement intended by the subject is determined to be the first movement or the second movement, a user (e.g., doctor, physical therapist, occupational therapist, rehabilitation trainer, subject, etc.), for example, can set whether the movement to be assisted should be the first movement or the second movement.

In the second mode, the control means 200 can determine, for example, whether the intensity of the biological signal exceeds a preset threshold, and if it is determined that the intensity of the biological signal exceeds the threshold, the control means 200 can determine the movement to be the first movement or the second movement, and if it is determined that the intensity of the biological signal does not exceed the threshold, the control means 200 can determine the movement to be the movement of weakness. Alternatively, the control means 200 can determine, for example, whether each of: the intensity of the biological signal acquired by the first acquisition means for acquiring the biological signal mainly by the first movement; and the intensity of the biological signal acquired by the second acquisition means for acquiring the biological signal mainly by the second movement, exceeds the threshold. If it is determined that the intensity of either of the biological signals exceeds the threshold, the control means 200 can determine the movement to be the first movement or the second movement; and if it is determined that the intensity of either of the biological signals does not exceed the threshold, the control means 200 can determine the movement to be the movement of weakness.

The threshold can be any value. The threshold may be a preset fixed value or a variable value. In the case of a variable value, the threshold can be varied, for example, for each subject. The threshold can be set, for example, based on the maximum value and/or minimum value of the intensity of the biological signal acquired from the subject. The threshold is, for example, a value between about 50% and about 95%, or a value between about 60% to about 90%, such as about 60%, about 70%, about 80% and the like, when the minimum value of the biological signal intensity is 0% and the maximum value of the biological signal intensity is 100%. The threshold may be set, for example, based on the maximum value and/or minimum value of the biological signal intensity when a load is applied to the target part. The threshold can be set, for example, based on the maximum value and/or minimum value of the biological signal intensity when a maximum load, a half of the maximum load, a minimum load, or the like, is applied to the target part.

The second mode distinguishes between the first movement or the second movement and the weakness. Thus, even if the biological signal due to the first movement and the biological signal due to the second movement cannot be distinguished from each other, the first movement or the second movement can be assisted. Whether the movement to be assisted should be the first movement or the second movement can be set by input from the outside. The second mode is particularly useful when, for example, the intensity and feature of the biological signal are so similar, or the intensity of the biological signal is so weak, that it is not possible to distinguish between the first movement and the second movement based on the intensity and feature of the biological signal. For example, in the case of assisting the hand-clenching movement and hand-opening movement where the biological signal from the hand-clenching movement and the biological signal from the hand-opening movement cannot be distinguished from each other, if it is determined that the movement intended by the subject is the hand-clenching movement (or the hand-opening movement) based on the intensity of the biological signal acquired during the execution of the movement assistance, the device 100 can be controlled to assist the hand-clenching movement; and if it is determined that the movement intended by the subject is the movement of weakness, the hand-opening movement can be assisted. Similarly, if it is determined that the movement intended by the subject is the hand-opening movement (or the hand-clenching movement), the device 100 can be controlled to assist the hand-opening movement; and if it is determined that the movement intended by the subject is the movement of weakness, the hand-clenching movement can be assisted. Whether to assist the hand-clenching movement or the hand-opening movement when it is determined that the movement is the hand-clenching movement (or the hand-opening movement) may be set by a doctor, or the like, in accordance with the subject's condition.

The biological signal sensing mode includes, for example, a third mode. The third mode is a mode in which the control means 200 determines whether the movement intended by the subject is the first movement or the second movement, or the movement of weakness, based on the feature of the biological signal, and control the device 100 in such a manner to assist either the first movement or the second movement. In the third mode, the control means 200 determines whether the movement intended by the subject is the first movement or the second movement, or the movement of weakness, based on the feature of the biological signal acquired during the execution of movement assistance; and if the movement intended by the subject is determined to be the first movement or the second movement, the device 100 is controlled to assist either one of the first movement and the second movement; and if the movement intended by the subject is determined to be the movement of weakness, the device 100 is controlled to assist the other one of the first movement and the second movement. When the movement intended by the subject is determined to be the first movement or the second movement, a user (e.g., doctor, physical therapist, occupational therapist, rehabilitation trainer, subject, etc.), for example, can set whether the movement to be assisted should be the first movement or the second movement.

In the third mode, the control means 200 uses a machine learning model prepared in advance to distinguish between the first movement or the second movement and the movement of weakness, and distinguishes between the first movement or the second movement and the movement of weakness, based on the feature of the biological signal. The machine learning model prepared in advance may be a model that has learned the feature of the biological signal and the label attached to the biological signal.

The machine learning model is similar to the machine learning model utilized in the first mode; however, the subject machine learning model has learned to distinguish between two states: the first movement or the second movement and the movement of weakness. Thus, the subject machine learning model is different from the machine learning model used in the first mode in this respect.

For example, a set of teaching data (input teaching data, output teaching data) for learning by the machine learning model so that the machine learning model can distinguish between the hand-opening movement or hand-holding movement and the movement of weakness may be: (a feature extracted from a biological signal acquired when the hand-opening movement or the hand-clenching movement is made, a value indicating either one of the hand-opening movement and the hand-clenching movement); (a feature extracted from a biological signal acquired when the movement of weakness is made, a value indicating the other one of the hand-opening movement and the hand-clenching movement). It is preferable to acquire teaching data from a plurality of subjects and to allow a plurality of teaching data to be learned. When the machine learning model prepared in this way is input with the feature extracted from the biological signal acquired when the subject makes a certain movement, the machine learning model can output either of: a value indicating that the certain movement is either one of the hand-opening movement and the hand-clenching movement; and a value indicating that the certain movement is the other one of the hand-opening movement and the hand-clenching movement.

In one embodiment, similar to the machine learning models utilized in the first mode, a plurality of machine learning models may be prepared for each stage of the subject's movement.

In another embodiment, similar to the machine learning model utilized in the first mode, the subject's movement stages may also be learned by the machine learning model.

The third mode distinguishes between the first movement or the second movement and the weakness based on the feature of the biological signal. Thus, even if the intensity of the biological signal is weak, the first movement or the second movement and the weakness can be distinguished with high accuracy, and the first movement or the second movement can be assisted. Whether the movement to be assisted should be the first movement or the second movement can be set by input from the outside (for example, the movement of the hand clenching or the movement of the hand opening). The third mode is particularly useful, for example, when the biological signal is so similar, or the intensity of the biological signal is so weak, that the first movement and the second movement cannot be distinguished based on the intensity and feature of the biological signal, and further, when the biological signal is so similar, or the intensity of the biological signal is so weak, that it is not possible to distinguish between the first movement or the second movement, or the movement of weakness.

For example, in the case of assisting the hand-clenching movement and hand-opening movement where the biological signal from the hand-clenching movement and the biological signal from the hand-opening movement cannot be distinguished from each other, if it is determined that the movement intended by the subject is the hand-clenching movement (or the hand-opening movement) based on the feature of the biological signal acquired during the execution of the movement assistance, the device 100 can be controlled to assist the hand-clenching movement; and if it is determined that the movement intended by the subject is the movement of weakness, the hand-opening movement can be assisted. Similarly, if it is determined that the movement intended by the subject is the hand-opening movement (or the hand-clenching movement), the device 100 can be controlled to assist the hand-clenching movement; and if it is determined that the movement intended by the subject is the movement of weakness, the hand-clenching movement can be assisted. Whether to assist the hand-clenching movement or the hand-opening movement when it is determined that the movement is the hand-clenching movement (or the hand-opening movement) may be set by a doctor, or the like, in accordance with the subject's condition.

The biological signal sensing mode includes, for example, a fourth mode. The fourth mode is a mode in which the control means 200 determines whether the movement intended by the subject is the first movement or the second movement, among a plurality of movements, based on the intensity of the biological signal, and control the device 100 in such a manner to assist the determined movement. In the fourth mode, the control means 200 determines whether the movement intended by the subject is the first movement or the second movement based on the intensity of the biological signal acquired during the execution of movement assistance; and if the movement intended by the subject is determined to be the first movement, the device 100 is controlled to assist the first movement; and if the movement intended by the subject is determined to be the second movement, the device 100 is controlled to assist the second movement. In the fourth mode, it may also be determined based on the intensity of the biological signal that the movement intended by the subject is a movement of weakness. In this case, the control means 200 may not control the device 100. This allows the device 100 not to be moved when the subject intends to make the movement of weakness.

That is, in the fourth mode, the control means 200 is configured to determine three states of (1) first movement, (2) second movement, and (3) movement of weakness (or unintended movement) based on the intensity of the biological signal acquired during the execution of the assistance so that the control means 200 controls the device 100 to assist the first movement when the subject intends the first movement, to assist the second movement when the subject intends the second movement, and not to assist the movement when the subject intends the movement of weakness (or when the subject does not intend to make a movement).

In the fourth mode, the control means 200 can determine, for example, whether the intensity of the biological signal exceeds a preset threshold, and if it is determined that the intensity of the biological signal exceeds the threshold, the control means 200 can determine the movement to be the first movement; and if it is determined that the intensity of the biological signal does not exceed the threshold, the control means 200 can determine the movement to be the second movement. Alternatively, the control means 200 can determine, for example, whether the intensity of the biological signal acquired by the first acquisition means for acquiring the biological signal mainly by the first movement exceeds the threshold, and whether the intensity of the biological signal acquired by the second acquisition means for acquiring the biological signal mainly by the second movement exceeds the threshold. If it is determined that the intensity of the biological signal acquired by the first acquisition means exceeds the threshold and that the intensity of the biological signal acquired by the second acquisition means does not exceed the threshold, the control means 200 can determine the movement to be the first movement. Further, if it is determined that the intensity of the biological signal acquired by the first acquisition means does not exceed the threshold and that the intensity of the biological signal acquired by the second acquisition means exceeds the threshold, the control means 200 can determine the movement to be the second movement. If it is determined that: both of the intensity of the biological signal acquired by the first acquisition and the intensity of the biological signal acquired by the second acquisition exceed the threshold; or neither of them exceed the threshold, it can be determined to be undeterminable or to be the movement of weakness.

The threshold can be any value. The threshold may be a preset fixed value or a variable value. In the case of a variable value, the threshold can be varied, for example, for each subject. The threshold can be set, for example, based on the maximum value and/or minimum value of the intensity of the biological signal acquired from the subject. The threshold is, for example, a value between about 50% and about 95%, or a value between about 60% to about 90%, such as about 60%, about 70%, about 80%, and the like, when the minimum value of the biological signal intensity is 0% and the maximum value of the biological signal intensity is 100%. The threshold may be set, for example, based on the maximum value and/or minimum value of the biological signal intensity when a load is applied to the target part. The threshold can be set, for example, based on the maximum value and/or minimum value of the biological signal intensity when a maximum load, a half of the maximum load, a minimum load, or the like, is applied to the target part.

In the fourth mode, the first movement and the second movement are distinguished based on the intensity of the biological signal. Therefore, the first movement or the second movement can be determined when, for example, the intensity of the biological signal exceeds a threshold. This makes it possible to assist the first movement or the second movement with high responsiveness. The effectiveness of rehabilitation increases as the first movement or the second movement is assisted with higher responsiveness.

In the fourth mode, for example, in order to exclude a state in which both the first movement and the second movement are assisted, it is also possible, during the second movement distinguishment, not to determine the movement to be the second movement if the intensity of the biological signal indicating the first movement exceeds the threshold, regardless of the intensity of the biological signal indicating the second movement.

For example, in the case of assisting the hand-clenching movement and hand-opening movement where the biological signal from the hand-clenching movement and the biological signal from the hand-opening movement can be distinguished from each other based on the intensity thereof, if it is determined that the movement intended by the subject is the hand-clenching movement based on the intensity of the biological signal acquired during the execution of the movement assistance, the device 100 can be controlled to assist the hand-clenching movement; and if it is determined that the movement intended by the subject is the hand-opening movement, the hand-opening movement can be assisted. For example, the device 100 can be controlled to assist a hand-clenching movement when the intensity of the biological signal acquired during the execution of movement assistance exceeds the threshold related to the hand-clenching movement; and the hand-opening movement can be assisted when the intensity of the biological signal acquired during the execution of movement assistance exceeds the threshold related to the hand-opening movement. Alternatively, for example, when the biological signal from the hand-clenching movement, the biological signal from the hand-opening movement, and the biological signal from the movement of weakness can be distinguished from one another by the intensity thereof, if it is determined that the movement intended by the subject is the hand-clenching movement based on the intensity of the biological signal acquired during the execution of the movement assistance, the device 100 can be controlled to assist the hand-clenching movement; if it is determined that the movement intended by the subject is the hand-opening movement, the hand-opening movement can be assisted; and if it is determined that the movement intended by the subject is the movement of weakness, the movement can be prevented from being assisted.

In addition, in order to exclude an antagonistic state in which both the muscle involved in the hand-clenching movement and the muscle involved in the hand-opening muscles contract, it is also possible, during the hand-clenching movement distinguishment, not to determine the movement to be the hand-clenching movement if the intensity of the biological signal indicating the hand-opening movement exceeds a certain threshold, regardless of the intensity of the biological signal indicating the hand-clenching movement.

The control signal generation means 222 is configured to generate control signals for controlling the device 100. The control signal generation means 222 generates control signals to control the device 100 in the mode selected by the mode selection means 221.

For example, when the movement sensing mode is selected by the mode selection means 221, the control signal generation means 222 can generate a control signal for controlling the device 100 so as not to interfere with the sensed movement of the subject, based on the movement of the subject sensed by the sensing means 400.

For example, when the biological signal sensing mode is selected by the mode selection means 221, the control signal generation means 222 can recognize the movement intended by the subject based on the biological signal acquired by the acquisition means 300, and generate a control signal for controlling the device 100 so as to assist the recognized movement. For example, when the first mode is selected by the mode selection means 221, the control signal generation means 222 can recognize whether the movement intended by the subject is the first movement or the second movement based on the feature of the biological signal acquired by the acquisition means 300, and generate a control signal for controlling the device 100 so as to assist the first movement or the second movement. As described above, the control signal generation means 222 can recognize whether the movement intended by the subject is the first movement or the second movement based on the feature of the biological signal, using a machine learning model prepared in advance. For example, when the second mode is selected by the mode selection means 221, the control signal generation means 222 can recognize whether the movement intended by the subject is the first movement or the second movement, or the movement of weakness, based on the intensity of the biological signal acquired by the acquisition means 300, and generate a control signal for controlling the device 100 so as to assist the first movement or the second movement. For example, when the third mode is selected by the mode selection means 221, the control signal generation means 222 can recognize whether the movement intended by the subject is the first movement or the second movement, or the movement of weakness, based on the feature of the biological signal acquired by the acquisition means 300, and generate a control signal for controlling the device 100 so as to assist the first movement or the second movement. As described above, the control signal generation means 222 can recognize whether the movement intended by the subject is the first movement or the second movement or the movement of weakness, based on the feature of the biological signal, using a machine learning model prepared in advance. For example, when the fourth mode is selected by the mode selection means 221, the control signal generation means 222 can recognize whether the movement intended by the subject is the first movement or the second movement, based on the intensity of the biological signal acquired by the acquisition means 300, and generate a control signal for controlling the device 100 so as to assist the first movement or the second movement. In the first and fourth modes, in addition to recognizing whether the movement intended by the subject is the first movement or the second movement, it is possible to recognize that the movement intended by the subject is the movement of weakness. When it is recognized that the movement intended by the subject is the movement of weakness, the control signal generation means 222 does not generate a control signal, or the control signal generation means 222 can generate a control signal for controlling the device 100 not to move.

The generated control signal is transmitted to the device 100 via the output unit 240, and the device 100 is controlled according to the control signal.

FIG. 2B shows an example of the configuration of the control means 200′, which is an alternative embodiment of the control means 200. The control means 200′ is different from the control means 200 in that the processor unit 220′ is equipped with the determination means 223. Components that are the same as those described with reference to FIG. 2A are denoted by the same reference numerals, and detailed description thereof is omitted here.

The control means 200′ comprises a reception unit 210, a processor unit 220′, a memory unit 230 and an output unit 240.

The processor unit 220′ controls the overall operation of the control means 200′. The processor unit 220′ reads the program stored in the memory unit 230 and executes the program. This allows the control means 200′ to function as a device that executes desired steps.

The memory unit 230 stores programs required for the execution of processing, data required for executing the programs, and the like. For example, the memory unit 230 may store a program for implementing the processing for assisting the movement of the target part of the subject (for example, the processing to be described below with reference to FIGS. 4, 5, 6, 7A, 7B, and 8). Here, it is possible to employ any way of storing the program on the memory unit 230. For example, the program may be pre-installed in the memory unit 230. Alternatively, the program may be installed in the memory unit 230 by being downloaded via a network, or may be installed in the memory unit 230 via a storage medium such as an optical disc or USB.

The processor unit 220′ comprises determination means 223, mode selection means 221 and control signal generation means 222.

The determination means 223 is configured to determine whether the magnitude of the force indicated by the received signal is less than a predetermined threshold. The predetermined threshold may be any numerical value, but is preferably a value with which it can be determined that no force is being produced. For example, the predetermined threshold can be a value greater than zero. The determination means 223 can determine whether the magnitude of the force is less than a predetermined threshold, based for example on a signal indicating the change in the angle of the arm unit 112 with respect to the base unit 111 when a constant torque is applied to the arm unit 112. For example, if there is a change in the angle, it is possible to determine that the magnitude of the force is greater than the predetermined threshold; and if there is no change in the angle, it is possible to determine that the magnitude of the force is less than the predetermined threshold. Thereby, the determination means 223 can determine whether the subject is exerting force or not.

When the determination means 223 determines that the magnitude of the force indicated by the received signal is equal to or greater than a predetermined threshold, it can be considered that the subject is exerting force. In this case, the received signal can be used as is for subsequent processing. This is because, as shown in FIG. 3, it is possible to identify the intended movement of the biological signal included in the received signal.

In this case, the output from the determination means 223 is passed to the mode selection means 221.

If the determination means 223 determines that the magnitude of the force indicated by the received signal is less than the predetermined threshold, it can be considered that the subject is not exerting any force. In this case, the received signal cannot be used for subsequent processing. This is because it is impossible to identify the intended movement of the biological signal included in the received signal.

In this case, some more processing is required to label the biological signals acquired from the subject as to what movement is intended.

Processing for labeling biological signals can be performed by any known technique. For example, a subject may be instructed to attempt a certain action (e.g., by speaking to him or showing an illustration), and the biological signal at which the subject attempts that action in response to the instruction may be labeled with that action. For example, it is possible to attached a label of “hand opening action” to a biological signal acquired when a subject is instructed to attempt to perform a hand-opening action (e.g., by speaking to him or showing an illustration) and when the subject attempts to perform the hand-opening action in response to the instruction. The biological signal at this stage may be, for example, a signal in the period from the rise to the fall of the signal. For example, it is possible to attached a label of “weakness” to a biological signal acquired when a subject is instructed to attempt to perform a relaxed action (e.g., by speaking to him or showing an illustration) and when the subject attempts to perform the relaxed action in response to the instruction. The biological signal at this stage may be, for example, a signal in the period from the rise to the fall of the signal. The labeled biological signals can be used for comparison (comparison regarding intensity, comparison regarding feature, etc.), machine learning, and the like.

The processing for labeling the biological signals may be performed by the control means 200′ or by means different from the control means 200′. Another means may be a means within the system 10 or a means outside the system 10. Note that the above example is based on the premise that biological signals can be detected from the subject. If the biological signal cannot be detected from the subject, therapy and/or rehabilitation is performed on the subject, for example, by any known technique. For example, therapy and/or rehabilitation for a subject can be performed using image training that makes the subject imagine moving the target part with a certain rhythm, and/or therapy that applies electrical stimulation to the target part.

In the example shown in FIGS. 2A and 2B, although each of the components of the control means 200 is provided within the control means 200, the present invention is not limited thereto. It is also possible for any of the components of the control means 200 to be provided outside the control means 200. For example, when the processor unit 220 and the memory unit 230 are each composed of separate hardware components, the respective hardware components may be connected to each other via any network. In such a case, any type of network may be used. The respective hardware components may be connected via a LAN, wirelessly, or wired, for example.

In the example shown in FIGS. 2A and 2B, although each of the components of the processor unit 220 is provided within the same processor unit 220, the present invention is not limited thereto. It is also within the scope of the present invention for the components of the processor unit 220 to be distributed across multiple processor units. In such a case, the plurality of processor units may be located within the same hardware component, or may be located within separate nearby or remote hardware components.

### (Processing by the System for Assisting the Movement of the Target Part of the Subject)

FIG. 4 is a flow chart showing an example of processing (processing 400) by a system 10 for assisting the movement of a target part of a subject. The processing 400 is performed in the processing means 200.

Before performing step S401, the subject will perform a preparatory operation for acquiring the first signal. First, the subject wears the device 100 on the target part. The subject then moves the target part with a first movement while the device 100 is controlled so as not to interfere with the movement of the target part. As a result, the subject moves the target part by the first movement within the self-movable range, and the sensing means 400 senses the self-movable range of the target part when the subject is attempting to move the target part by the first movement.

Optionally, the subject may move the target part with a second movement (and a third movement . . . an nth movement), while the device 100 is controlled so as not to interfere with the movement of the target part. As a result, the subject moves the target part with the second movement (and the third movement . . . the nth movement) within the self-movable range, and the sensing means 400 senses the self-movable range of the target part when the subject is attempting to move the target part with the second movement (and the third movement . . . the nth movement).

The subject then moves the target part with the first movement while the device 100 is controlled to load the target part. At this stage, the acquisition means 300 acquires a biological signal at which the subject is attempting to move the target part with the first movement, and the sensing means 400 senses the movement or force exerted by the target part at which the subject is attempting to move the target part with the first movement. The load is applied in a direction opposite to the direction of the first movement. For example, if the first movement and the second movement are paired movements, the load may be applied in a direction that causes the target part to move with the second movement. Preferably, this step varies the magnitude of the load during the first movement, or this step is repeatedly performed multiple times with different loads, to perform multiple samplings. This is because the amount of data that can be used in subsequent processing can be increased.

At this stage, before and after the subject tries to move the target part with the first movement, the biological signal of the subject in the state of weakness may be acquired.

Optionally, the subject moves the target part with a second movement (and a third movement, . . . an nth movement) while the device 100 is controlled to load the target part. At this stage, the acquisition means 300 acquires a biological signal at which the subject is attempting to move the target part with the second movement (and the third movement, . . . the nth movement), and the sensing means 400 senses the movement or force exerted by the target part at which the subject is attempting to move the target part with the second movement (and the third movement, . . . the nth movement). The load is applied in a direction opposite to the direction of the second movement (and the third movement, . . . the nth movement). For example, if the first movement and the second movement are paired movements, the load may be applied in a direction that causes the target part to move with the first movement. Preferably, this step varies the magnitude of the load during the second movement, or this step is repeatedly performed multiple times with different loads, to perform multiple samplings. This is because the amount of data that can be used in subsequent processing can be increased.

At this stage, before and after the subject tries to move the target part with the second movement (and the third movement, . . . the nth movement), the biological signal of the subject in the state of weakness may be acquired.

In step S401, the reception unit 210 of the processing means 200 receives the first signal. The first signal is a signal at which the subject is attempting to move the target part with the first movement, and the first signal may indicate: a biological signal at which the subject is attempting to move the target part with the first movement; the self-movable range of the target part at which the subject is attempting to move the target part with the first movement; and the magnitude of the force at which the subject is attempting to move the target part with the first movement. If multiple samplings were performed in the preparatory operation before step S401, the first signal may include data from the multiple samplings. The first signal may include a biological signal at which the subject is in a state of weakness before and after attempting to move the target part with the first movement.

The first signal may be received from the acquisition means 300 and the sensing means 400. The first signal may, for example, be received directly from the acquisition means 300 and the sensing means 400, or may be received indirectly from another device in communication with the acquisition means 300 and the sensing means 400. Once the first signal is received, the reception unit 210 passes the first signal to the processor unit 220 for subsequent processing.

When the processor unit 220 receives the first signal, the mode selection means 221 of the processor unit 210 in step S402 selects a mode for controlling the device based on the first signal. The mode selection means 221 can select a mode for controlling the device 100 from among a plurality of modes. The plurality of modes may include, for example, a movement sensing mode and a biological signal sensing mode. The plurality of modes may include a first mode, a second mode, a third mode, and a fourth mode.

In step S403, the control signal generation means 222 of the processor unit 220 generates a control signal for controlling the device 100 in the selected mode, and transmits the generated control signal to the device 100 via the output unit 240, thereby controlling the device 100 in the selected mode. This enables the device 100 to assist the first movement of the subject.

The processing 400 allows the device 100 to operate in different modes for different subjects, enabling movement assistance according to the subject's condition. In addition, a mode suitable for the subject can be automatically selected, and the burden on doctors, physical therapists, occupational therapists, rehabilitation trainers, etc., who assist rehabilitation can be reduced. Furthermore, since the only operation required by the subject is the preparatory operation before step S401, the mode setting of the device 100 can be performed with a simple operation, and thus, the burden on the subject can also be reduced.

In the above example, it has been described that the processing 400 is performed by the control means 200; however, the processing 400 can be similarly performed by the control means 200′.

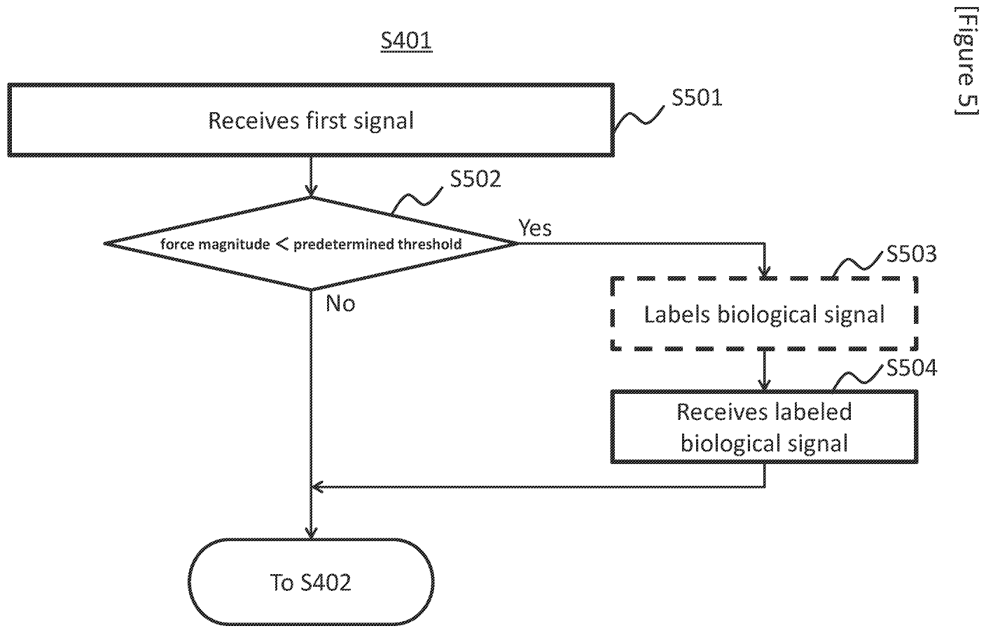

FIG. 5 is a flow chart showing an example of the detailed flow of step S401 in the processing 400 performed by the control means 200′. The processing shown in FIG. 5 is performed to distinguish subjects who are unable to apply force from the target part or cannot move the target part.

In step S501, the receiver 210 of the processing means 200′ receives the first signal. The first signal is a signal at which the subject is attempting to move the target part with the first movement, and the first signal may indicate: a biological signal at which the subject is attempting to move the target part with the first movement; the self-movable range of the target part at which the subject is attempting to move the target part with the first movement; and the magnitude of the force at which the subject is attempting to move the target part with the first movement.

The first signal may be received from the acquisition means 300 and the sensing means 400. The first signal may, for example, be received directly from the acquisition means 300 and the sensing means 400, or may be received indirectly from another device in communication with the acquisition means 300 and the sensing means 400. Once the first signal is received, the reception unit 210 passes the first signal to the processor unit 220′ for subsequent processing.

In step S502, the determination means 223 of the processor unit 220′ determines whether the magnitude of the force indicated by the received first signal is less than a predetermined threshold. The predetermined threshold may be any numerical value, but is preferably a value with which it can be determined that no force is being produced. For example, the predetermined threshold can be a value greater than zero. For example, the determination means 223 may determine whether the magnitude of the force is less than a predetermined threshold based on a signal indicating a change in the angle of the arm unit 112 with respect to the base unit 111 when a constant torque is applied to the arm unit 112. For example, if there is a change in the angle, it can be determined that the force magnitude is greater than a predetermined threshold; and if there is no change in the angle, it can be determined that the force magnitude is less than the predetermined threshold. Accordingly, in step S502, it is determined whether or not the subject is exerting force.

If it is determined in step S502 that the magnitude of the force indicated by the received first signal is greater than or equal to the predetermined threshold, the processing proceeds to step S402 described above. This is because the first signal received in step S501 can also be used in subsequent steps.

If it is determined in step S502 that the magnitude of the force indicated by the received first signal is less than the predetermined threshold, the processing proceeds to step S503. This is because it is not possible to identify the intended movement of the biological signal included in the first signal received in step S501, and therefore the information cannot be used in subsequent steps.

In step S503, biological signals acquired from the subject are labeled. Step S503 may be performed in the processor unit 220′, but can be performed in means other than the processor unit 220′. Processing for labeling biological signals acquired from a subject can be performed by any known technique. In the processing for labeling biological signals acquired from the subject, a label for indicating that the first movement has been intended is attached to a biological signal acquired when the subject is caused to attempt a first movement.

In step S504, the processing means 200′ receives the labeled biological signal. If step S503 is performed by means other than the processor unit 220′, the reception unit 210 of the processing unit 200′ receives the labeled biological signal. The labeled biological signal will be used in place of the first biological signal that was included in the first signal. The received biological signal is passed to the processor unit 220′ for subsequent processing, and the processing proceeds to step S402.

By the above-described processing, a subject who cannot exert force from the target part or who cannot move the target part is determined, and a biological signal is acquired differently for such a subject, so that even a subject who cannot exert force from the target part or who cannot move the target part can receive movement assistance from the device 100. In addition, it is possible to automatically distinguish subjects whose biological signals need to be acquired separately, and thus to reduce the burden on doctors, physical therapists, occupational therapists, rehabilitation trainers, and the like who assist rehabilitation.

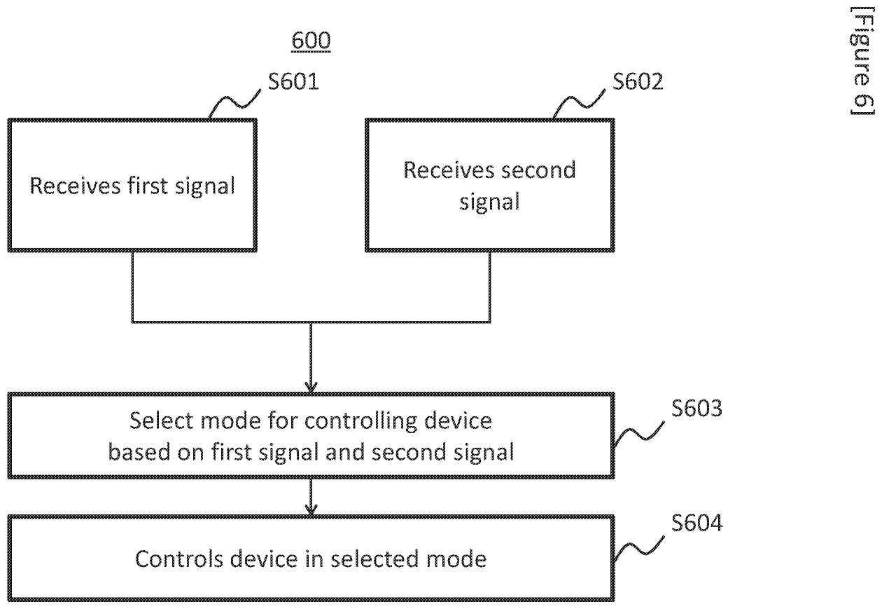

FIG. 6 is a flowchart showing another example of processing (processing 600) by the system 10 for assisting the movement of a target part of a subject. The processing 600 differs from the processing 400 in that the processing 600 uses a second signal in addition to the first signal. Although the processing 600 will be described below as being performed in the control means 200, the processing 600 can be performed in the control means 200′ as well.

In step S601, the receiver 210 of the processing means 200 receives the first signal. Since step S601 is the same as step S401, description thereof is omitted here. As in step S401, the subject may perform a preparatory operation before step S601 is performed. The first signal may include data from multiple samplings if multiple samplings were performed in the preparatory operation prior to performing step S601.

In step S602, the reception unit 210 of the processing means 200 receives the second signal. The second signal is a signal at which the subject is attempting to move the target part with the second movement, and the second signal may indicate: a biological signal at which the subject is attempting to move the target part with the second movement; the self-movable range of the target part at which the subject is attempting to move the target part with the second movement; and the magnitude of the force at which the subject is attempting to move the target part with the second movement. The second signal may include data from multiple samplings if the multiple samplings were performed in preparatory operations prior to performing step S601. The second signal may include a biological signal at which the subject is in a state of weakness before and after attempting to move the target part with the second movement.

The second signal may be received from the acquisition means 300 and the sensing means 400. The second signal may, for example, be received directly from the acquisition means 300 and the sensing means 400 or may be received indirectly from another device in communication with the acquisition means 300 and the sensing means 400. Once the second signal is received, the reception unit 210 passes the second signal to the processor unit 220 for subsequent processing.

Note that step S602 may be performed by steps similar to steps S501 to S504 shown in FIG. 5.

Alternatively, after receiving the first and second signals in steps S601 and S602, the intensity of the first signal may be compared to the intensity of the second signal instead of step S502. This makes it possible to determine whether the intensity of the first signal and the intensity of the second signal are different enough to distinguish them. The comparison may include, for example, determining whether the finite difference between the intensity of the first signal and the intensity of the second signal exceeds a predetermined threshold, and the comparison includes judging from the difference in the outputs of the neural network being greater than or equal to a certain value, or from the information vector distance and information entropy in information theory. The predetermined threshold can be any value, and it may be, for example, a value between about 1% and about 50%, or a value between about 10% and about 40% of the intensity of the first signal or the intensity of the second signal, such as, about 5%, about 10%, about 15%, or the like.

When it is determined that the intensity of the first signal and the intensity of the second signal are significantly different from each other or that the finite difference between the intensity of the first signal and the intensity of the second signal is greater than or equal to a predetermined threshold, the processing proceeds to step S603. This is because the first and second signals received in steps S601 and S602 can also be used in subsequent steps.

When it is determined that the intensity of the first signal and the intensity of the second signal are not significantly different or that the finite difference between the intensity of the first signal and the intensity of the second signal is less than a predetermined threshold, the processing proceeds to step S503. This is because the first and second signals received in steps S601 and S602 cannot be distinguished from each other and cannot be used in subsequent steps.

In step S503, biological signals acquired from the subject are labeled. In the processing for labeling biological signals acquired from the subject, a label for indicating that the first movement has been intended is attached to a biological signal acquired when the subject is caused to attempt a first movement, and a label for indicating that the second movement has been intended is attached to a biological signal acquired when the subject is caused to attempt a second movement.

In step S504, the processing means 200′ receives the labeled biological signals. If step S503 is performed by means other than the processor unit 220′, the reception unit 210 of the processing unit 200′ receives the labeled biological signals. The labeled biological signal will be used in place of: the first biological signal included in the first signal; and the second biological signal included in the second signal. The received biological signal is passed to the processor unit 220′ for subsequent processing and the processing proceeds to step S603.

When the processor unit 220 receives the first signal and the second signal, the mode selection means 221 of the processor unit 210 selects, in step S603, a mode for controlling the device based on the first signal and the second signal. The mode selection means 221 can select a mode for controlling the device 100 from among a plurality of modes. The plurality of modes may include, for example, a movement sensing mode and a biological signal sensing mode. The plurality of modes may include a first mode, a second mode, a third mode, and a fourth mode.

In step S604, the control signal generation means 222 of the processor unit 220 generates a control signal for controlling the device 100 in the selected mode, and transmits the generated control signal to the device 100 via the output unit 240, thereby controlling the device 100 in the selected mode. This enables the device 100 to assist the first movement or the second movement of the subject.

The processing 600 allows the device 100 to operate in different modes for different subjects, enabling movement assistance according to the subject's condition. In addition, a mode suitable for the subject can be automatically selected, and the burden on doctors, physical therapists, occupational therapists, rehabilitation trainers, etc., who assist rehabilitation can be reduced.

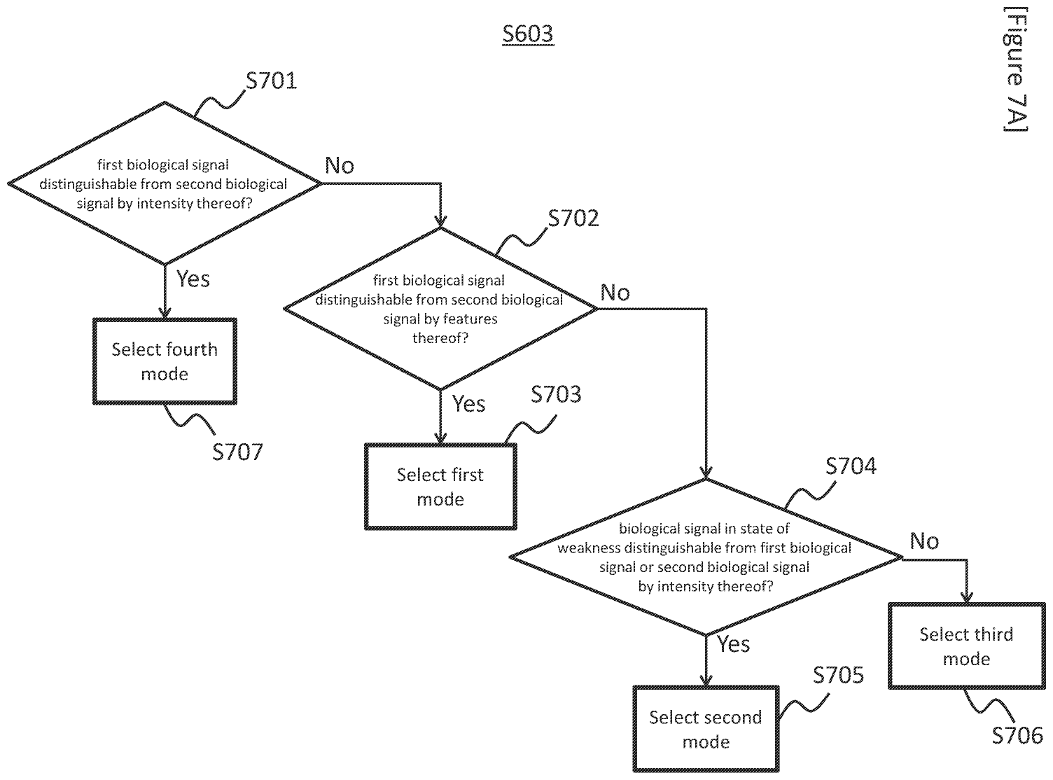

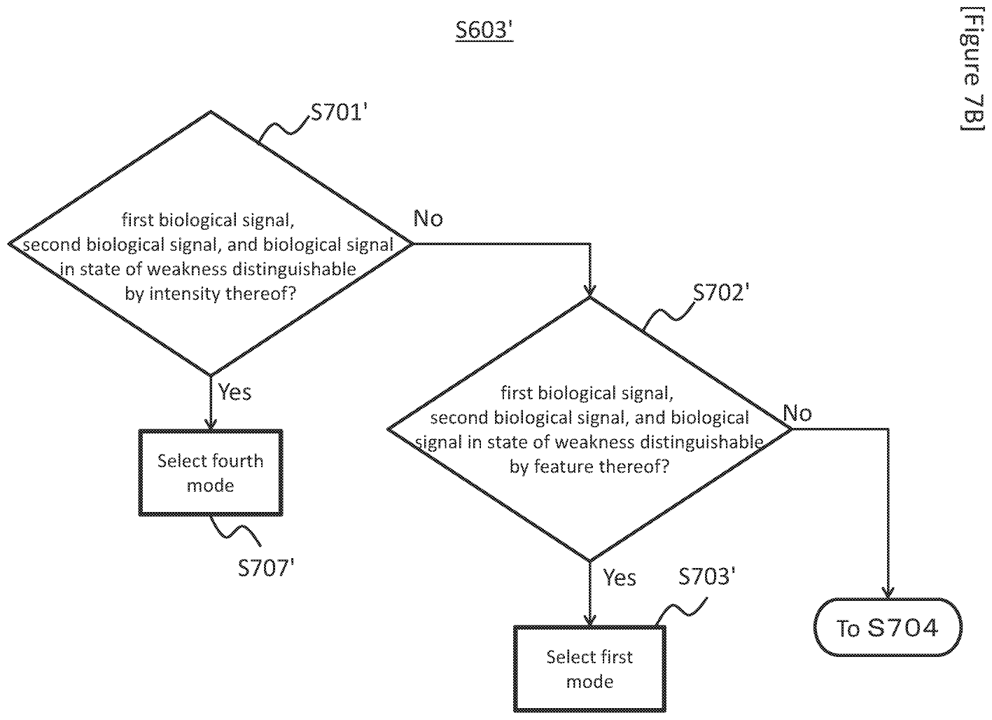

FIG. 7A is a flowchart showing an example of the detailed flow of step S603 in processing 600. The processing shown in FIG. 7A is performed for the mode selection means 221 of the processor unit 220 to select a mode for controlling the device 100 from the first to fourth modes.

In step S701, the mode selection means 221 determines whether or not the first biological signal and the second biological signal can be distinguished by the intensity thereof.

Whether or not the first biological signal and the second biological signal can be distinguished from each other based on the intensity thereof is determined, for example, by determining whether either one of the intensity of the first biological signal and the intensity of the second biological signal exceeds a threshold. For example, if the intensity of the first biological signal exceeds the threshold whereas the intensity of the second biological signal does not exceed the threshold, or if the intensity of the second biological signal exceeds the threshold whereas the intensity of the first biological signal does not exceed the threshold, it can be determined that the first biological signal and the second biological signal can be distinguished from each other by the intensity thereof. On the other hand, for example, if the intensity of the first biological signal does not exceed the threshold and the intensity of the second biological signal does not exceed the threshold either, or if the intensity of the first biological signal exceeds the threshold and the if the intensity of the second biological signal also exceeds the threshold, it can be determined that the first biological signal and the second biological signal cannot be distinguished from each other by the intensity thereof. Alternatively, whether or not the first biological signal and the second biological signal can be distinguished by the intensity thereof can be determined by, for example, as follows: determining whether each of the intensity P₁₁ of the first biological signal acquired by the first acquisition means that mainly acquires the biological signal from the first movement, the intensity P₁₂ of the first biological signal acquired by the second acquisition means that mainly acquires the biological signal from the second movement, the intensity P₂₁ of the second biological signal acquired by the first acquisition means, and the intensity P₂₂ of the second biological signal acquired by the second acquisition means, exceeds the threshold; and determining, in either of the cases where (P₁₁, P₁₂)=(1, 0) and (P₂₁, P₂₂)=(0, 1) and where (P₁₁, P₁₂)=(0, 1) and (P₂₁, P₂₂)=(1, 0), that the first biological signal and the second biological signal can be distinguished from each other by the intensity thereof. Here, 1 indicates that the intensity exceeds the threshold, and 0 indicates that the intensity does not exceed the threshold. On the other hand, in either of the cases where (P₁₁, P₁₂)=(1, 1) or (P₁₁, P₁₂)=(0, 0) and where (P₂₁, P₂₂)=(1, 1) or (P₂₁, P₂₂)=(0, 0), it can be determined that the first biological signal and the second biological signal cannot be distinguished from each other by the intensity thereof. Alternatively, if (P₁₁, P₁₂) and (P₂₁, P₂₂) are different, it can be determined that the first biological signal and the second biological signal can be distinguished by the intensity thereof; and if (P₁₁, P₁₂) and (P₂₁, P₂₂) are the same, it can be determined that the first biological signal and the second biological signal cannot be distinguished by the intensity thereof.

Note that the threshold may be set separately for the first biological signal and the second biological signal, or may be set commonly for the first biological signal and the second biological signal. Also, the threshold may be set separately for the biological signal acquired by the first acquisition means and the biological signal acquired by the second acquisition means, or may be set in common. The threshold may be set based on, for example, the maximum value and/or minimum value of the intensity of the first biological signal or the second biological signal, or the average value of the intensity of the first biological signal or the second biological signal. The threshold may be, for example, a value between 50% and 95%, or a value between 60% and 90%, such as 60%, 70%, 80% and the like, when the minimum value of the intensity of the first biological signal or the second biological signal is 0% and the maximum value of the intensity of the first biological signal or the second biological signal is 100%.

If it is determined in step S701 that the first biological signal and the second biological signal can be distinguished from each other based on the intensity thereof, the processing proceeds to step S707, whereas, if it is determined that the first biological signal and the second biological signal cannot be distinguished based on the intensity thereof, the processing proceeds to step S702.

In step S702, the mode selection unit 221 determines whether or not the first biological signal and the second biological signal can be distinguished from each other by the features thereof.

Whether or not the first biological signal and the second biological signal can be distinguished from each other based on the features thereof is determined, for example, by whether or not a machine learning model prepared in advance can distinguish between the first biological signal and the second biological signal. The machine learning model prepared in advance may be a model that has learned the feature of the biological signal and the label attached to the biological signal, and specifically, may be a two-state distinguishment model that is capable of distinguishing between two states. For example, if there is a significant difference between the output when the feature of the first biological signal is input to the machine learning model and the output when the second biological signal is input to the machine learning model, it can be determined that the first biological signal and the second biological signal can be distinguished by the features thereof. For example, if there is no significant difference between the output when the feature of the first biological signal is input to the machine learning model and the output when the second biological signal is input to the machine learning model, it can be determined that the first biological signal and the second biological signal cannot be distinguished by the features thereof. Here, the criterion for the significant difference can be any criterion. For example, the criterion can be a strict criterion or a loose criterion in accordance with the subject's condition. In one example, the correct answer rate of the prediction by the machine learning model can be calculated, and if the correct answer rate is equal to or higher than a predetermined threshold, it is determined that there is a significant difference, and if the correct answer rate is less than the predetermined threshold, it is determined that there is no significant difference.

If it is determined in step S702 that the first biological signal and the second biological signal can be distinguished by the features thereof, the processing proceeds to step S703, whereas if it is determined that the first biological signal and the second biological signal cannot be distinguished by the features thereof, the processing proceeds to step S704.

In step S703, the mode selection means 221 selects the first mode. The first mode is a mode in which the control means 200 determines whether the movement intended by the subject is the first movement or the second movement, from among a plurality of movements, based on the feature of the biological signal, to control the device 100 in such a manner to assist the determined movement. The first mode is possible precisely because it is possible to distinguish between the first biological signal and the second biological signal by the features thereof. When the first mode is selected, the machine learning model used in step S702 may be made to learn the feature of the first biological signal and the feature of the second biological signal so that the machine learning model prepared in advance can be tuned to suit that subject. In the first mode of control, a tuned machine learning model may be utilized to recognize operations.

In step S704, the mode selection means 221 determines whether or not the biological signal in the state of weakness and the first biological signal or the second biological signal can be distinguished by the intensity thereof. A biological signal in the state of weakness can be received together with the first signal or the second signal in step S601 or step S602.

Whether or not the biological signal in the state of weakness and the first biological signal or the second biological signal can be distinguished by the intensity thereof can be determined, for example, by whether or not either one of the intensity of the first biological signal or the second biological signal and the intensity of the biological signal in the state of weakness exceeds a threshold. For example, if the intensity of the first biological signal or the second biological signal exceeds the threshold but the intensity of the biological signal in the state of weakness does not exceed the threshold, or if the intensity of the first biological signal or the second biological signal does not exceed the threshold and the intensity of the biological signal in the state of weakness does not exceed the threshold, it can be determined that the first biological signal or the second biological signal and the biological signal in the state of weakness can be distinguished by the intensity thereof. On the other hand, for example, if the intensity of the first biological signal or the second biological signal does not exceed the threshold and the intensity of the biological signal in the state of weakness does not exceed the threshold, or if the intensity of the first biological signal or the second biological signal exceeds the threshold and the intensity of the biological signal in the state of weakness also exceeds the threshold, it can be determined that the first biological signal or the second biological signal and the biological signal in the state of weakness cannot be distinguished by the intensity thereof. Alternatively, whether or not the first biological signal and the second biological signal can be distinguished by the intensity thereof can be determined by, for example, as follows: determining whether each of the intensity P₁₁ of the first biological signal acquired by the first acquisition means that mainly acquires the biological signal from the first movement, the intensity P₁₂ of the first biological signal acquired by the second acquisition means that mainly acquires the biological signal from the second movement, the intensity P₂₁ of the second biological signal acquired by the first acquisition means, the intensity P₂₂ of the second biological signal acquired by the second acquisition means, the biological signal P₃₁ in the state of weakness acquired by the first acquisition means, and the biological signal P₃₂ in the state of weakness acquired by the second acquisition means, exceeds the threshold; and determining, where (P₁₁, P₁₂) and/or (P₂₁, P₂₂) differs from (P₃₁, P₃₂), that the first biological signal or the second biological signal and the biological signal in the state of weakness can be distinguished by the intensity thereof; and determining, where (P₁₁, P₁₂) and (P₂₁, P₂₂) and (P₃₁, P₃₂) are the same, that the first biological signal or the second biological signal and the biological signal in the state of weakness cannot be distinguished by the intensity thereof.

Note that the threshold may be set separately for the first biological signal, the second biological signal, and the biological signal in the state of weakness, or the threshold may be set in common for the first biological signal, the second biological signal, and the biological signal in the state of weakness. Also, the threshold may be set separately for the biological signal acquired by the first acquisition means and the biological signal acquired by the second acquisition means, or may be set in common. The threshold may be set based on, for example, the maximum value and/or minimum value of the intensity of the first biological signal or the second biological signal, or the average value of the intensity of the first biological signal or the second biological signal. The threshold may be, for example, a value between 50% and 95%, or a value between 60% and 90%, such as 60%, 70%, 80% and the like, when the minimum value of the intensity of the first biological signal or the second biological signal is 0% and the maximum value of the intensity of the first biological signal or the second biological signal is 100%.

If it is determined in step S704 that the biological signal in the state of weakness and the first biological signal or the second biological signal can be distinguished by the intensity thereof, the processing proceeds to step S705, whereas if it is determined that the biological signal in the state of weakness and the first biological signal or the second biological signal cannot be distinguished by the intensity thereof, the processing proceeds to step S706.

In step S705, the mode selection means 221 selects the second mode. The second mode is a mode in which the control means 200 determines whether the movement intended by the subject is the first movement or the second movement, or the movement of weakness based on the intensity of the biological signal, to control the device 100 to assist either the first movement or the second movement based on the determination. The second mode is possible precisely because it is possible to distinguish between the biological signal in the state of weakness and the first biological signal or the second biological signal based on the intensity thereof. When the second mode is selected, thresholds and conditions for distinguishing between the biological signal in the state of weakness and the first biological signal or the second biological signal may be determined to suit the subject.

In step S706, the mode selection means 221 selects the third mode. The third mode is a mode in which the control means 200 determines whether the movement intended by the subject is the first movement or the second movement, or the movement of weakness, based on the features of the biological signals, to control the device 100 in such a manner to assist either the first movement or the second movement. When the third mode is selected, the machine learning model capable of distinguishing between the biological signal of the first movement or the second movement and the biological signal of in the state of weakness (the two-state distinguishment model) may be made to learn the feature of the first biological signal or the feature of the second biological signal and the feature in the state of weakness so that the machine learning model can be tuned to suit that subject. In the third mode of control, a tuned machine learning model may be utilized to recognize operation.

The third mode is a mode that is feasible when the biological signal in the state of weakness and the first biological signal or the second biological signal can be distinguished from each other by the features thereof. However, if it is not possible to distinguish between the biological signal in the state of weakness and the first biological signal and the second biological signal based on the features thereof, then the subject may undergo another rehabilitation before receiving the movement assistance from the device 100. Another rehabilitation is, for example, to train the subject to be able to make the first movement or the second movement and the movement of weakness while still distinguishing between them.

In step S707, the mode selection means 221 selects the fourth mode. The fourth mode is a mode in which the control means 200 determines whether the movement intended by the subject is the first movement or the second movement based on the intensity of the biological signal to control the device 100 in such a manner to assists the determined movement. The fourth mode is possible precisely because it is possible to distinguish between the first biological signal and the second biological signal by the intensity thereof. When the fourth mode is selected, thresholds and conditions for distinguishing between the first biological signal and the second biological signal may be determined to suit that subject. In this way, the mode for controlling the device 100 can be selected according to the intensity or feature of the biological signal from the subject. This enables flexible movement assistance according to the subject's condition. In addition, a mode suitable for the subject can be automatically selected, and thus, the burden on doctors, physical therapists, occupational therapists, rehabilitation trainers, etc., who assist rehabilitation can be reduced.

FIG. 7B is a flowchart showing another example (S603′) of the detailed flow of step S603 in the processing 600.

In step S701′, the mode selection means 221 determines whether or not the first biological signal, the second biological signal, and the biological signal in the state of weakness can be distinguished by the intensity thereof. The biological signal in the state of weakness can be received together with the first signal or the second signal in step S601 or step S602.

Whether or not the first biological signal, the second biological signal, and the biological signal in the state of weakness can be distinguished by the intensity thereof can be determined by, for example, as follows: determining whether each of the intensity P₁₁ of the first biological signal acquired by the first acquisition means that mainly acquires the biological signal from the first movement, the intensity P 12 of the first biological signal acquired by the second acquisition means that mainly acquires the biological signal from the second movement, the intensity P₂₁ of the second biological signal acquired by the first acquisition means, the intensity P₂₂ of the second biological signal acquired by the second acquisition means, the biological signal P₃₁ in the state of weakness acquired by the first acquisition means, and the biological signal P₃₂ in the state of weakness acquired by the second acquisition means, exceeds the threshold; and determining, where (P₁₁, P₁₂), (P₂₁, P₂₂) and (P₃₁, P₃₂) differ from one another, that the first biological signal, the second biological signal, and the biological signal in the state of weakness can be distinguished by the intensity thereof; and determining, where at least two of (P₁₁, P₁₂), (P₂₁, P₂₂) and (P₃₁, P₃₂) are the same, that the first biological signal, the second biological signal, and the biological signal in the state of weakness cannot be distinguished by the intensity thereof.

The threshold may be set separately for the first biological signal, the second biological signal, and the biological signal in the state of weakness, or may be set commonly for the first biological signal, the second biological signal, and the biological signal in the state of weakness. Also, the threshold may be set separately for the biological signal acquired by the first acquisition means and the biological signal acquired by the second acquisition means, or may be set in common. The threshold may be set, for example, based on the maximum value and/or minimum value of the intensity of the first biological signal or the second biological signal, or based on the average value of the intensity of the first biological signal or the second biological signal. The threshold may be, for example, a value between 50% and 95%, or a value between 60% and 90%, such as 60%, 70%, 80% and the like, when the minimum value of the intensity of the first biological signal or the second biological signal is 0% and the maximum value of the intensity of the first biological signal or the second biological signal is 100%.

If it is determined in step S701′ that the first biological signal, the second biological signal, and the biological signal in the state of weakness can be distinguished from one another by the intensity thereof, the processing proceeds to step S707′; and if it is determined that the first biological signal, the second biological signal, and the biological signal in the state of weakness cannot be distinguished by the intensity thereof, the processing proceeds to step S702′.

For example, in step S702′, the mode selection means 221 determines whether or not the first biological signal, the second biological signal, and the biological signal in the state of weakness can be distinguished by the features thereof.

Whether or not the first biological signal, the second biological signal, and the biological signal in the state of weakness can be distinguished by the features thereof is determined by, for example, whether or not a machine learning model prepared in advance can distinguish between the first biological signal, the second biological signal, and the biological signal in the state of weakness. The machine learning model prepared in advance may be a model that has learned the feature of the biological signal and the label attached to the biological signal, and specifically, may be a three-state distinguishment model that is capable of distinguishing between three states. For example, if there is a significant difference between the output when the feature of the first biological signal is input to the machine learning model, the output when the feature of the second biological signal is input to the machine learning model, and the output when the feature of the biological signal in the state of weakness is input to the machine learning model, it can be determined that the first biological signal, the second biological signal, and the biological signal in the state of weakness can be distinguished by the features thereof. For example, if there is no significant difference between the output when the feature of the first biological signal is input to the machine learning model, the output when the feature of the second biological signal is input to the machine learning model, and the output when the feature of the biological signal in the state of weakness is input to the machine learning model, it can be determined that the first biological signal, the second biological signal, and the biological signal in the state of weakness cannot be distinguished by the features thereof. Here, the criterion for the significant difference can be any criterion. For example, the criterion can be a strict criterion or a loose criterion in accordance with the subject's condition. In one example, the correct answer rate of the prediction by the machine learning model can be calculated, and if the correct answer rate is equal to or higher than a predetermined threshold, it is determined that there is a significant difference, and if the correct answer rate is less than the predetermined threshold, it is determined that there is no significant difference.

If it is determined in step S702′ that the first biological signal, the second biological signal, and the biological signal in the state of weakness can be distinguished by the features thereof, the processing proceeds to step S703′; and if it is determined that the first biological signal, the second biological signal, and the biological signal in the state of weakness cannot be distinguished by the features thereof, the processing proceeds to step S704.

Step S703′ is a step similar to step S703 shown in FIG. 7A. In step S703′, the mode selection means 221 selects the first mode.

The first mode is a mode in which the control means 200 determines whether the movement intended by the subject is the first movement, the second movement, or the movement of weakness, based on the features of the biological signals, to control the device 100 in such a manner to assist the determined movement. The first mode is possible precisely because it is possible to distinguish between the first biological signal, the second biological signal, and the biological signal in the state of weakness by the features thereof. When the first mode is selected, the machine learning model used in step S702′ may be made to learn the feature of the first biological signal, the feature of the second biological signal, and the biological signal in the state of weakness so that the machine learning model prepared in advance can be tuned to suit that subject. In the first mode of control, a tuned machine learning model may be utilized to recognize operations.

Since step S704 is the same step as step S704 shown in FIG. 7A, description thereof is omitted here.

Step S707′ is a step similar to step S707 shown in FIG. 7B.

In step S707′, the mode selection means 221 selects the fourth mode. The fourth mode is a mode in which the control means 200 determines whether the movement intended by the subject is the first movement, the second movement, or the movement of weakness based on the intensity of the biological signals. The fourth mode is possible precisely because it is possible to distinguish between the first biological signal, the second biological signal, and the biological signal in the state of weakness by the intensity thereof.

In the above example, it has been described that the first biological signal and the second biological signal as a whole are determined in each step and the mode is selected; however, the present invention is not limited thereto. For example, the first biological signal and the second biological signal may be divided into a plurality of stages, determination may be made at each step for each of the plurality of stages, and a mode suitable for each of the plurality of stages may be selected. For example, of the first biological signal and the second biological signal, the fourth mode can be selected for the stage determined as Yes in step S701 or step S701′; of the first biological signal and the second biological signal, the first mode may be selected for the stage determined as Yes in step S702 or step S702′; of the first biological signal and the second biological signal, the second mode may be selected for the stage determined as Yes in step S704; and of the first biological signal and the second biological signal, the third mode may be selected for the stage determined as No in step S704. This makes it possible to select an appropriate mode according to the movement state of the subject.

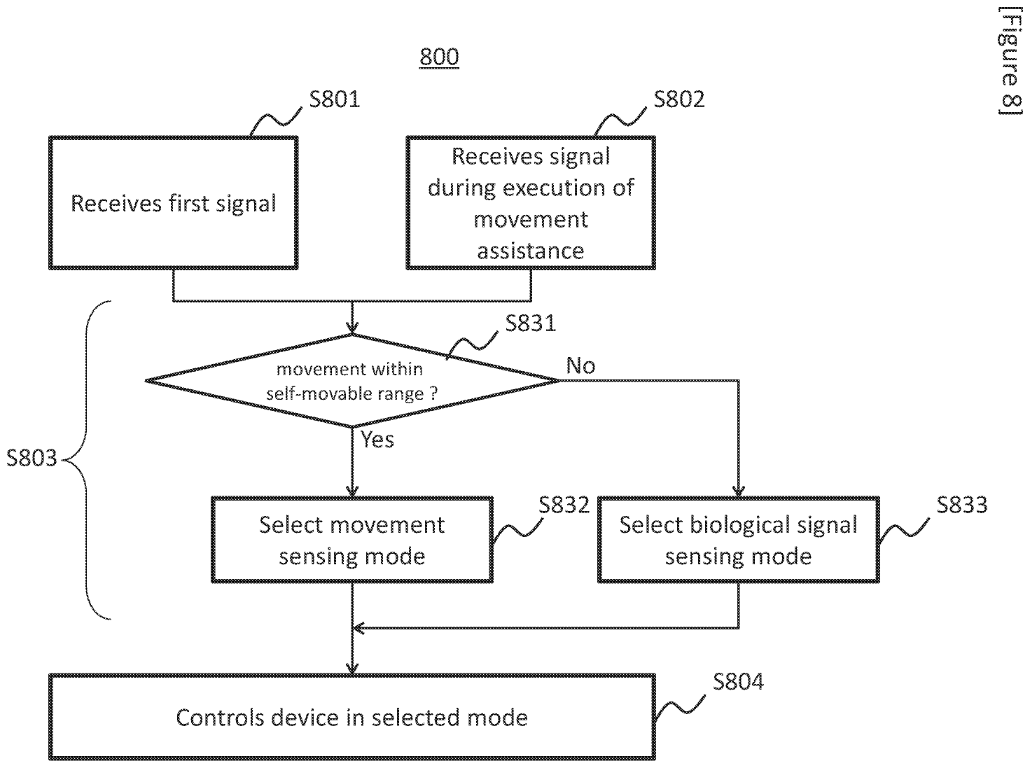

FIG. 8 is a flowchart showing an example of processing (processing 800) by the system 10 for assisting the movement of a target part of a subject. The processing 800 is the processing for selecting a mode for controlling the device 100 during the execution of the movement assistance. Although the processing 800 will be described below as being performed in the control means 200, the processing 800 can also be performed in the control means 200′ in a similar manner.

In step S801, the receiver 210 of the processing means 200 receives the first signal. Step S801 is performed before the execution of movement assistance. Since step S801 is the same as step S401, description thereof is omitted here.

Step S801, like step S401, may be replaced by steps S501 to S504, as shown in FIG. 5.

Step S802 is performed during the execution of movement assistance; and in step S802, the reception unit 210 of the processing means 200 receives a signal at which the subject is attempting to move the target part during the execution of movement assistance. The signal at which the subject is attempting to move the target part during the execution of movement assistance indicates a biological signal at which the subject is attempting to move the target part during the execution of movement assistance, and the movement of the subject attempting to move the target part during the execution of movement assistance.

The signal at which the subject is attempting to move the target part during the execution of movement assistance may be received from the acquisition means 300 and the sensing means 400. The signal at which the subject is attempting to move the target part during the execution of movement assistance may, for example, be received directly from the acquisition means 300 and the sensing means 400, or may be received indirectly from another device in communication with the acquisition means 300 and the sensing means 400. When the signal at which the subject is attempting to move the target part during the execution of movement assistance is received, the reception unit 210 passes the signal to the processor unit 220 for subsequent processing.

Step S803 is performed when the processor unit 220′ receives the first signal and the signal at which the subject is attempting to move the target part during the execution of movement assistance. In step S803, the mode selection means 221 of the processor unit 220 selects a mode for controlling the device.

Step S803 includes: step S831; and step S832 or step S833.

In step S831, the mode selection means 221 determines whether or not the movement of the subject indicated by the signal at which the subject is attempting to move the target part during the execution of movement assistance is within the self-movable range. This can be performed by comparing to the self-movable range indicated by the first signal. Since the subject's range of movement may vary due to fatigue, etc., the determination area may be larger or smaller than the previously measured range of movement; and when approaching the determination boundary surface, some force assist may be provided in the first or second direction.

If the subject's movement is determined to be within the self-movable range, the processing proceeds to step S832; and if the subject's movement is determined not to be within the self-movable range, the processing proceeds to step S833.

In step S832, the mode selection means 221 selects a movement sensing mode. The movement sensing mode is a mode in which the control means 200 controls the device 100 based on the subject's movement. In the movement sensing mode, the control means 200 can control the device 100 so as not to interfere with sensed subject's movement. That is, in the movement sensing mode, the device 100 is driven to counteract the inherent resistance of the device 100 due to the interference between the constituent components of the device 100, or the like. This allows the subject to move the target part as if the subject were not wearing the device 100.

In step S833, the mode selection unit 221 selects a biological signal sensing mode. The biological signal sensing mode is a mode for controlling the device 100 based on the subject's biological signals. In the biological signal sensing mode, the movement intended by the subject is recognized based on the biological signal, and the device 100 can be controlled to assist the recognized movement. Here, the biological signal sensing mode may be one of a first mode, a second mode, a third mode and a fourth mode. One of the first mode, the second mode, the third mode, and the fourth mode can be selected by, for example, performing some processing similar to the processing shown in FIG. 7A or 7B in step S833. Alternatively, one of the first mode, the second mode, the third mode and the fourth mode can be selected, for example, after step S801 and before step S802, i.e., before the execution of movement assistance, by performing some processing similar to the processing shown in FIG. 7A or 7B.

When the mode is selected in step S803, then the control signal generation means 222 of the processor unit 220 generates, in step S804, a control signal for controlling the device 100 in the selected mode, and transmits the generated control signal to the device 100 via the output unit 240 to control the device 100 in the selected mode. Thereby, the first or second movement of the subject is assisted by the device 100.

Steps S802 to S804 can be repeated during the execution of movement assistance, so that a suitable mode can always be selected during the execution of movement assistance.

For example, in step S833 of step S803, different modes may be selected according to the stage even for the same movement of the target part during the execution of movement assistance. For example, different modes can be selected for each stage (e.g., the angle around a finger joint) even fora hand-opening movement. For example, at a stage where the first movement and the second movement can be distinguished by the intensity of the biological signal, the fourth mode can be selected; at a stage where the first movement and the second movement can be distinguished by the feature of the biological signal, the first mode can be selected; at a stage where the first movement or the second movement and the movement of weakness can be distinguished by the intensity of the biological signal, the second mode can be selected; and at a stage where the first movement or the second movement and the movement of weakness can be distinguished by the feature of the biological signal, the third mode can be selected. In this way, even for a single movement, the selection of a mode suitable for the stage of that movement improves the accuracy of movement recognition, which in turn leads to improved rehabilitation efficiency.

For example, when the first mode or the third mode is selected in step S833, it is possible to recognize, in step S804, the movement of the target part in accordance with the stage of movement of the target part during the execution of movement assistance, using a machine learning model suitable for that stage. As a result, the movement recognition accuracy can be improved, and more efficient rehabilitation can be achieved. For example, in the case of moving a target part of a living body around a joint related to the part, it is possible to recognize the movement of the target part using the first machine learning model when the joint angle is 0 degrees≤θ<30 degrees; it is possible to recognize the movement of the target part using the second machine learning model when the joint angle is 30 degrees≤θ<60 degrees; it is possible to recognize the movement of the target part using the third machine learning model when the joint angle is 60 degrees≤θ<90 degrees; and it is possible to recognize the movement of the target part using the fourth machine learning model when the joint angle is 90 degrees≤θ.

The processing 800 allows the mode to be switched according to the self-movable range of the subject's movement, and thus enables the movement assistance according to the subject's condition and the subject's movement. In addition, within the range where the subject can move by himself, the control can be performed in the movement sensing mode instead of the biological signal sensing mode described below, thereby reducing the opportunities to use the biological signal sensing mode and reducing erroneous recognition related to biological signal sensing.

Although the above example describes the steps of processing 400, 600 and 800 as occurring in a particular order, the order described is only an example. The steps of processing 400, 600 and 800 can be performed in any order that is logically possible. For example, in processing 600, it may be possible to perform step S602 before step S601. For example, in step S603, it may be possible to perform steps S701, S704, and S707 in parallel.

Also, the steps of the processing 400, 600 and 800 may be omitted in one embodiment, and may be replaced with other steps in another embodiment.

It has been described that: in the examples described above with reference to FIGS. 4, 5, 6, 7A, 7B, and 8, the processing of each step shown in FIGS. 4, 5, 6, 7A, 7B, and 8 is implemented by the processor unit 120 and the program stored in the memory unit 130; however, the present invention is not limited thereto. Among the various types of processing in the steps shown in FIGS. 4, 5, 6, 7A, 7B, and 8, at least one type of processing may be achieved by a hardware configuration such as a control circuit.

The present invention is not limited to the embodiments described above. It is understood that the present invention is to be construed in scope only by the Scope of Claims. It is understood that a person skilled in the art can implement an equivalent scope from the description of specific preferred embodiments of the present invention and based on the description of the present invention and common technical knowledge.

### INDUSTRIAL APPLICABILITY

The present invention is useful for providing a program for controlling a device for assisting the movement of a target part of a subject, a system therefor, a method for configuring a device for assisting the movement of a target part of a subject, and the like.

### REFERENCE SIGNS LIST

10 system for assisting the movement of a target part of a subject
100 device for assisting the movement of a target part of a subject
200 control means
300 acquisition means
400 sensing means

1. A method for configuring a device for assisting movement of a target part of a subject, the method comprising:
receiving a first signal at which the subject is attempting to move the target part with a first movement, wherein the first signal at least indicates a first biological signal at which the subject is attempting to move the target part with the first movement, a self-movable range of the target part at which the subject is attempting to move the target part with the first movement, and a magnitude of force at which the subject is attempting to move the target part with the first movement;
selecting a mode for controlling the device based on the received first signal; and
setting the device to the selected mode.

2. The method of claim 1, further comprising:
determining that the magnitude of the force is less than a predetermined threshold; and
receiving, as a first biological signal, a biological signal labeled to indicate the intention of making the first movement if the magnitude of the force is less than the predetermined threshold.

3. The method of claim 1, wherein selecting a mode for controlling the device comprises: selecting a movement sensing mode when the subject is moving the target part within the self-movable range, and
wherein controlling the device in the movement sensing mode comprises:
sensing a movement by the target part of the subject; and
controlling the device based on the sensed movement so as not to interfere with the movement.

4. The method program of claim 1,
wherein selecting a mode for controlling the device comprises:
selecting a biological signal sensing mode at which the subject is moving the target part outside the self-movable range, and
wherein controlling the device in the biological signal sensing mode comprises:
receiving a biological signal acquired when the subject intends to move the target part;
determining that the movement intended by the subject is the first movement based on the biological signal; and
controlling the device to assist the first movement.

5. The method of claim 1, further comprising:
receiving a second signal at which the subject is attempting to move the target part with a second movement, wherein the second signal at least indicates a second biological signal at which the subject is attempting to move the target part with the second movement, a self-movable range of the target part at which the subject is attempting to move the target part with the second movement, and a magnitude of force at which the subject is attempting to move the target part with the second movement, wherein selecting a mode for controlling the device comprises:
selecting a mode for controlling the device based on the first signal and the second signal.

6. The method of claim 5, wherein selecting a mode for controlling the device comprises:
determining whether the first biological signal can be distinguished from the second biological signal by features thereof; and
selecting a first mode, when the first biological signal can be distinguished from the second biological signal by the features thereof.

7. The method of claim 6, further comprising: learning the feature of the first biological signal and the feature of the second biological signal when the first mode is selected; wherein controlling the device in the first mode comprises:
receiving a biological signal acquired when the subject intends to move the target part;
determining whether the movement intended by the subject is the first movement or the second movement based on the learned features; and
controlling the device to support the determined movement.

8. The method of claim 5, wherein selecting the mode for controlling the device comprises:
determining whether the first biological signal can be distinguished from the second biological signal by features thereof;
determining, when the first biological signal cannot be distinguished from the second biological signal by the features thereof, whether a biological signal at which the subject is in a state of weakness can be distinguished from the first biological signal or the second biological signal by intensity thereof;
selecting a second mode, when the biological signal at which the subject is in a state of weakness can be distinguished from the first biological signal or the second biological signal by the intensity thereof; and
selecting a third mode, when the biological signal at which the subject is in a state of weakness cannot be distinguished from the first biological signal or the second biological signal by the intensity thereof.

9. The method of claim 8, wherein controlling the device in the second mode comprises:
receiving a biological signal acquired when the subject intends to move the target part;
determining whether the movement intended by the subject is the first movement or the second movement, or a movement of weakness, based on the intensity of the biological signals;
controlling the device to support either one of the first movement and the second movement when the movement intended by the subject is determined to be the first movement or the second movement; and
controlling the device to assist the other one of the first movement and the second movement when the movement intended by the subject is determined to be the movement of weakness.

10. The method of claim 8, further comprising:
learning the feature of the first biological signal or the feature of the second biological signal and the feature of the biological signal in the state of weakness, when the third mode is selected, wherein controlling the device in the third mode comprises:
receiving a biological signal acquired when the subject intends to move the target part;
determining whether the movement intended by the subject is the first movement or the second movement, or a movement of weakness, based on the features of the biological signals;
controlling the device to support either one of the first movement and the second movement when the movement intended by the subject is determined to be the first movement or the second movement; and
controlling the device to assist the other one of the first movement and the second movement when the movement intended by the subject is determined to be the movement of weakness.

11. The method of claim 5, wherein selecting the mode for controlling the device comprises:
determining whether the first biological signal can be distinguished from the second biological signal by intensity thereof; and
selecting, when the first biological signal can be distinguished from the second biological signal by the intensity thereof, a fourth mode.

12. The method of claim 11, wherein controlling the device in the fourth mode comprises:
receiving a biological signal acquired when the subject intends to move the target part;
determining whether the movement intended by the subject is the first movement or the second movement based on intensity of the biological signal; and
controlling the device to assist the determined movement.

13. The method of claim 1, wherein the target part is a part of the upper body.

14. The method of claim 13, wherein the target part is a finger.

15. The method of claim 5, wherewith the first movement is a hand-clenching movement and the second movement is a hand-opening movement.

16. A system for assisting movement of a target part of a subject, the system comprising:
a device for assisting movement of a target part of a subject;
acquisition means of acquiring a biological signal from the subject;
sensing means of sensing movement of the subject; and
control means of controlling the device, the control means configured to perform:
receiving a first signal at which the subject is attempting to move the target part with a first movement, from the acquisition means and the sensing means, wherein the first signal at least indicates a first biological signal at which the subject is attempting to move the target part with the first movement, a self-movable range of the target part at which the subject is attempting to move the target part with the first movement, and a magnitude of force at which the subject is attempting to move the target part with the first movement;
selecting a mode for controlling the device based on the received first signal; and
controlling the device in the selected mode.

17. A storage medium storing a program for controlling a device for assisting movement of a target part of a subject, the causing a processor unit to perform processing comprising:
receiving a first signal at which the subject is attempting to move the target part with a first movement, wherein the first signal at least indicates a first biological signal at which the subject is attempting to move the target part with the first movement, a self-movable range of the target part at which the subject is attempting to move the target part with the first movement, and a magnitude of force at which the subject is attempting to move the target part with the first movement;
selecting a mode for controlling the device based on the received first signal; and
controlling the device in the selected mode.
